(19) United States
(12) Patent Application Publication
(10) Pub. No.: US 2024/0139870 A1
(43) Pub. Date: May 2, 2024

(54) Laser Crafting Apparatus, System, and Method

(71) Applicant: Cricut, Inc., South Jordan, UT (US)

(72) Inventors: Sterling Kingdon, Cedar Hills, UT (US); Joe Martin, South Jordan, UT (US); Andrew James Yuill, Salt Lake City, UT (US); Kurt Stalsberg, Salt Lake City, UT (US); Tanner Hesterman, South Jordan, UT (US); Richard Petty, South Jordan, UT (US); Kyle Kenneth Johnson, Eagle Mountain, UT (US); Devin Higgs Anderson, Eagle Mountain, UT (US); Muchuan Chen, Sandy, UT (US); Cole Chamberlain, American Fork, UT (US); Adam Worsham, Bountiful, UT (US); Colter Leys, Salt Lake City, UT (US); Everett Sidney Kettle, Saratoga Springs, UT (US); Marc Korbuly, Salt Lake City, UT (US); Stephan Clark, South Jordan, UT (US); Jesse Anderegg, South Jordan, UT (US); Chloe Georgiades, Mill Valley, UT (US)

(73) Assignee: Cricut, Inc., South Jordan, UT (US)

(21) Appl. No.: 18/549,327

(22) PCT Filed: Mar. 8, 2022
(86) PCT No.: PCT/US2022/019403

§ 371 Date: Sep. 6, 2023

Related U.S. Application Data
(60) Provisional application No. 63/158,335, filed on Mar. 8, 2021.
(60) Provisional application No. 63/158,354, filed on Mar. 8, 2021.
(60) Provisional application No. 63/158,356, filed on Mar. 8, 2021.
(60) Provisional application No. 63/158,357, filed on Mar. 8, 2021.
(60) Provisional application No. 63/158,736, filed on Mar. 9, 2021.

(51) Int. Cl. B23K 26/12; B23K 26/70; B23K 37/02; B23K 37/04

(52) U.S. Cl. CPC B23K 26/127; B23K 26/706; B23K 37/0211; B23K 37/04

(57) ABSTRACT

A laser crafting apparatus for directing electromagnetic radiation toward a workpiece may include various features. For example, the laser crafting apparatus may include a material support tray that is removably supported within an internal volume of the laser crafting apparatus. Further, the apparatus may include pre-filter disposed in a ventilation pathway between a workspace region of the internal volume and an extractor fan. The laser crafting apparatus may include a laser carriage assembly that houses a laser module and the assembly may include a lens tray detachably coupled to the support structure of the laser carriage assembly. In various embodiments, the laser crafting apparatus includes a lid having a radiation attenuation layer and a fire suppression layer.

### CROSS-REFERENCES TO RELATED APPLICATIONS

This application claims the benefit of, and priority to, U.S. provisional patent application No. 63/158,354 entitled Laser Cutting Machine Mat and Material Alignment filed on Mar. 8, 2021, U.S. provisional patent application No. 63/158,357 entitled Laser Cutting Machine Lid filed on Mar. 8, 2021, U.S. provisional patent application No. 63/158,335 entitled Laser Cutting and Engraving Machine filed on Mar. 8, 2021, U.S. provisional patent application No. 63/158,356 entitled Ventilation Systems, Methods, and Apparatus for Laser Cutting Machines filed on Mar. 8, 2021, and U.S. provisional patent application No. 63/158,736 entitled Laser Cutting Machine Devices, Systems, and Methods filed on Mar. 9, 2021, all of which are incorporated herein by reference.

### FIELD

This disclosure relates to laser crafting apparatuses, devices, systems, and methods, and more particularly to assemblies, features, structures, configurations, and/or operations pertaining to laser crafting apparatuses, devices, systems, and methods.

### BACKGROUND

While conventional laser cutting devices have proven to be acceptable for various applications, such devices are nevertheless susceptible to improvements that may enhance their overall performance and cost. Therefore, a need exists to develop improved laser crafting devices that advance the art.

### SUMMARY

The subject matter of the present disclosure has been developed in response to the present state of the art, and in particular, in response to the problems and needs in the art that have not yet been fully solved by currently available laser cutting devices. Accordingly, the present disclosure has been developed to overcome many or all of the above-discussed shortcomings in the art, in accordance with various embodiments.

Disclosed herein, according to various embodiments, is a laser crafting apparatus configured to direct electromagnetic radiation toward a workpiece. The laser crafting apparatus may include a housing and a lid pivotably coupled to the housing. The housing and the lid may collectively at least partially define an internal volume of the laser crafting apparatus. The laser crafting apparatus may also include a rail assembly mounted to the housing and a laser carriage assembly coupled to the rail assembly, the laser carriage assembly comprising a laser module configured to emit electromagnetic radiation. In various embodiments, the laser crafting apparatus is configured to move the laser carriage assembly along the rail assembly within the internal volume and relative to the workpiece disposed within the internal volume.

The laser crafting apparatus may further include a material support tray that is removably supported within the internal volume such that a user can position the workpiece on the material support tray when the material support tray is removed from the internal volume of the laser crafting apparatus and subsequently load the material support tray and the workpiece supported thereon into the internal volume. The housing may include a workspace bed that is configured to at least one of receive, engage, support, and retain the material support tray in a known loaded position relative to the rail assembly within the internal volume. For example, the workspace bed may define a nested region configured to receive the material support tray therewithin. The workspace bed may comprise a plurality of upwardly extending keying pins and the material support tray comprises a plurality of keying recesses configured to align with and respectively receive the plurality of upwardly extending keying pins to facilitate consistent and repeatable loading of the material support tray in the known loaded position.

In various embodiments, the workspace bed is operably coupled to a lift mechanism configured to raise and lower the workspace bed within the internal volume of the laser crafting apparatus. In various embodiments, the laser crafting apparatus includes at least one retention clip configured to be detachably coupled to the material support tray to facilitate securement of the workpiece to the material support tray. The housing of the apparatus may include a shelf within the internal volume of the laser crafting apparatus configured to support the at least one retention clip when not in use for workpiece securement. The shelf may define a slot configured to receive a stem portion of the retention clip.

In various embodiments, the material support tray comprises a rigid mesh body for supporting the workpiece thereon, wherein the rigid mesh body defines a plurality of cells configured to detachably receive a stem portion of the at least one retention clip. The rigid mesh body may have a honeycomb structure. In various embodiments, the material support tray comprises an upper frame and a lower frame, wherein the upper frame is coupled to the lower frame with the rigid mesh body sandwiched between the upper frame and the lower frame. The upper frame may comprise alignment features to facilitate alignment and positioning of the workpiece upon the material support tray. In various embodiments, the upper frame comprises a raised rib portion extending upward from a corner segment of the upper frame.

In various embodiments, the laser crafting apparatus may define a ventilation pathway through which ventilation air is configured to flow during operation of the laser crafting apparatus. The ventilation pathway comprises at least a workspace region of the internal volume of the laser crafting apparatus. The laser crafting apparatus may include an extractor fan configured to pull the ventilation air through the ventilation pathway and ultimately force the ventilation air out of the internal volume of the laser crafting apparatus. In various embodiments, the laser crafting apparatus includes a pre-filter disposed in the ventilation pathway between the workspace region of the internal volume of the laser crafting apparatus and the extractor fan. The pre-filter may have a filter frame retaining a filter media, wherein the filter frame is detachably coupled to the housing of the laser crafting apparatus.

In various embodiments, a baffle plate may be disposed in the ventilation pathway between the pre-filter and the extractor fan. The apparatus may further include a tunnel in the ventilation pathway between the pre-filter and the extractor fan. The tunnel may have a converging cross-section, relative to a flow direction of the ventilation air, from the pre-filter toward the extractor fan. In various embodiments, the laser crafting apparatus further includes a hose module detachably coupled to the housing of the laser crafting apparatus, and the extractor fan may be a component of the hose module. The apparatus may include one or more hardware interlock features configured to prevent operation of the laser crafting apparatus in response to the hose module being detached from the housing of the laser crafting apparatus.

In various embodiments, the hose module may be connectable to the housing of the laser crafting apparatus in two different orientations, such that an outlet of the hose module can be switched to face in either a left or a right direction relative to the housing of the laser crafting apparatus. The hose module may be configured to redirect incoming ventilation air about 90 degrees to exit the hose module via the outlet. In various embodiments, the extractor fan is a centrifugal fan.

The hose module comprises two electrical connectors, wherein each electrical connector of the two electrical connectors is separately and individually connectable to a single electrical connection port extending from the housing of the laser crafting apparatus, according to various embodiments. The housing of the laser crafting apparatus may include a rear panel having a rear surface that defines a socket, wherein the hose module is detachably coupled at the socket. The hose module may comprise an interface plate configured to detachably engage the socket, wherein an inlet of the hose module is defined by the interface plate. The interface plate may be detachable from the hose module to allow access to the extractor fan. In various embodiments, the interface plate defines at least one finger scoop to facilitate separation of the interface plate from the hose module. In various embodiments, the hose module comprises a fan casing having a first portion and a second portion, wherein the first portion and the second portion of the fan casing collectively define airflow surfaces around the extractor fan, and wherein the first portion of the fan casing is mounted to the interface plate and is separable from the second portion of the fan casing to allow access to the extractor fan.

In various embodiments, the housing of the laser crafting apparatus at least partially defines an intake pathway. The intake pathway may be a portion of the ventilation pathway and the intake pathway may be configured to redirect the ventilation air from one or more intake ports defined by a bottom panel of the housing of the laser crafting apparatus to one or more delivery ports facing the workspace region of the internal volume of the laser crafting apparatus. The intake pathway may at least be partially defined by a front panel of the housing of the laser crafting apparatus. In various, the intake pathway comprises an L-shaped intake channel at least partially defined by the front panel of the laser crafting apparatus. The L-shaped intake channel of the intake pathway may have a vertical plenum and an upper horizontal plenum. The L-shaped intake channel of the intake pathway may be disposed forward of workspace region of the internal volume of the laser crafting apparatus. In various embodiments, the upper horizontal plenum fluidly connects the vertical plenum to the one or more delivery ports, wherein the upper horizontal plenum is configured to horizontally straighten the ventilation air before the ventilation air passes through the one or more delivery ports to the workspace region of the internal volume of the laser crafting apparatus. The L-shaped intake channel may have a lower horizontal plenum that fluidly connects the one or more intake ports to the vertical plenum. The ventilation air in the lower horizontal plenum may flow generally toward a front surface of the laser crafting apparatus and the ventilation air in the upper horizontal plenum flows generally toward a rear surface of the laser crafting apparatus.

In various embodiments, the one or more delivery ports are configured to deliver laminar air to the workspace region of the internal volume of the laser crafting apparatus. The one or more delivery ports may be configured such that ventilation air exiting the one or more delivery ports forms a curtain of air, wherein the curtain of air has a width that is greater than a width of a material support tray disposed within the workspace region of the internal volume of the laser crafting apparatus.

In various embodiments, the apparatus further includes at least one atmospheric sensor configured to detect a composition of air that is at least one of within and flowing out of the internal volume of the laser crafting apparatus. In various embodiments, the laser crafting apparatus further includes at least one temperature sensor configured to detect a temperature of at least one of the laser module and air within the internal volume of the laser crafting apparatus. In various embodiments, the laser crafting apparatus further includes an accelerometer coupled to the laser carriage assembly configured to detect movement (or lack thereof) of the laser carriage assembly. In various embodiments, the laser crafting apparatus further includes a flame sensor configured to detect a presence of flames within the internal volume of the laser crafting apparatus. In various embodiments, the laser crafting apparatus further includes a glass-break sensor configured to detect breakage of the lid. In various embodiments, the laser crafting apparatus further includes the laser carriage assembly comprises an optical sensor configured to detect a proximity of a top surface of the workpiece to the laser module. In various embodiments, the laser crafting apparatus further includes one or more hardware interlock features configured to prevent operation of the laser crafting apparatus in response to the lid not being closed (i.e., in response to the laser crafting apparatus being in an open configuration). The one or more hardware interlock features may be coupled in control communication with a controller, wherein in response to the one or more hardware interlock features detecting the lid being opened during an operation on the workpiece, the controller is configured to pause the operation on the workpiece while enabling subsequent resumption of the operation on the workpiece.

In various embodiments, the lid is pivotably coupled to the housing via a hinge structure. The hinge structure may include a pivoting arm having a first portion pivotably coupled to the housing and a second portion coupled to the lid. The second portion of the pivoting arm may be coupled to a fire suppression layer of the lid such that force transfer between the pivoting arm and the lid is exclusively via the fire suppression layer. The hinge structure may include a damping device coupled to the pivoting arm, wherein the damping device is configured to slow rotation of the lid between an open position and a closed position. The first portion of the pivoting arm is perpendicular to the second portion. The pivoting arm may include a curved portion extending between the first portion and the second portion.

The first portion may have a first end pivotably coupled to the housing and a second end, opposite the first end, coupled to a third end of the curved portion. The curved portion may have a fourth end coupled to a fifth end of the second portion. The second portion may have a sixth end opposite the fifth end. In various embodiments, the fifth end of the second portion is closer to the first end of the first portion than the second end of the first portion.

In various embodiments, the hinge structure further includes a damping device coupled to the pivoting arm, wherein the damping device is configured to slow rotation of the lid between an open position and a closed position. The damping device may be an extension damper that is configured to damp rotation of the lid as the extension damper elongates. In various embodiments, the extension damper comprises a seventh end pivotably coupled to the housing of the laser crafting apparatus and an eighth end that is pivotably coupled to at least one of the second end of the first portion of the pivoting arm and the third end of the curved portion of the pivoting arm.

Also disclosed herein, according to various embodiments, is a laser carriage assembly for a laser crafting apparatus. The laser carriage assembly may include a support structure, a laser module mounted to the support structure and configured to emit electromagnetic radiation along a beam axis toward a workpiece, and a lens tray detachably coupled to the support structure. The lens tray may define a first optic window and the lens tray may include a first optical lens extending across the first optic window. In various embodiments, when the lens tray is in an installed position relative to the support structure, the laser module is aligned with the lens tray such that the beam axis extends through the first optic window and intersects the first optical lens.

The support structure may comprise a lower base plate, and when the lens tray is in the installed position the lens tray is positioned between the laser module and the lower base plate. The lower base plate may include a nozzle extending downward and away from the laser module. The nozzle may be configured to direct compressed air toward the workpiece. The beam axis may extend through the nozzle. In various embodiments, the lower base plate defines a compressed air channel configured to deliver the compressed air from a compressed air source to the nozzle. The laser carriage assembly may further include a ring gasket disposed around the beam axis in sealing engagement between the nozzle of the lower base plate and a lower surface of the lens tray that circumscribes the first optic window when the lens tray is in the installed position. The ring gasket may define a passage that fluidly connects the compressed air channel to the nozzle such that the compressed air is routed through the ring gasket to the nozzle. In various embodiments, the laser carriage assembly further includes a fan and a heat sink coupled to the support structure, wherein the heat sink is disposed around the laser module and the fan is configured to blow cooling air across the heat sink and around the laser module. The laser carriage assembly may include a detachable fan cover forming a top surface of a casing of the laser carriage assembly, wherein the detachable fan cover detachably secured via magnets.

The lens tray defines one or more cooling air windows disposed around the first optic window through which the cooling air from the fan flows. The lower base plate may comprise one or more louvres positioned below the one or more cooling air windows, wherein the one or more louvres are configured to direct the cooling air away from parallel with the beam axis. In various embodiments, the one or more louvres are configured to direct the cooling air in a direction that is between about 45 degrees and about 90 degrees from the beam axis. In various embodiments, the one or more louvres have a concave upper surface. In various embodiments, the one or more louvres are configured to direct the cooling air rearward, relative to the laser crafting apparatus.

The laser carriage assembly may further include a visible light module coupled to the support structure and disposed adjacent the laser module, wherein the visible light module is configured to emit visible light parallel to the beam axis. The laser carriage assembly may further include an optical sensor coupled to the support structure, wherein the optical sensor is configured to emit radiation along a sensor axis and receive reflected radiation from an upper surface of the workpiece to determine a distance between the laser module and the upper surface of the workpiece. In various embodiments, the lens tray defines a second optic window and the lens tray includes a second optical lens extending across the second optic window. When the lens tray is in the installed position relative to the support structure, the optical sensor is aligned with the lens tray such that the sensor axis extends through the second optic window and intersects the second optical lens, according to various embodiments.

The laser carriage assembly may further include one or more hardware interlock features configured to prevent operation of the laser crafting apparatus in response to the lens tray being detached from the support structure (i.e., in response to the lens tray not being in the installed position). The lens tray may include a top portion, which defines the first optic window, and a flange portion extending from at least a portion of a periphery of the top portion. The flange portion may extend from front and side portions of the periphery of the top portion. In various embodiments, the flange portion of the lens tray is configured to engage and at least partially surround corresponding perimeter surfaces of the lower base plate. In various embodiments, interior surfaces of the flange portion of the lens tray comprise one or more engagement features that are configured to reversibly engage with corresponding engagement features on the perimeter surfaces of the lower base plate. The laser carriage assembly may further include an O-ring is disposed around the beam axis in sealing engagement between a lower end of the laser module and an upper surface of the lens tray that circumscribes the first optic window when the lens tray is in the installed position.

Also disclosed herein, according to various embodiments, is a lid for a laser crafting apparatus. The lid may include a radiation attenuation layer and a fire suppression layer coupled to the radiation attenuation layer. The lid may have a perimeter that comprises a front edge, a rear edge opposite the front edge, and opposing lateral side edges, the radiation attenuation layer and the fire suppression layer may be parallel to each other, and both the radiation attenuation layer and the fire suppression layer may extend continuously within the perimeter such that a majority of a body mass of the lid is comprised of the radiation attenuation layer and the fire suppression layer.

In various embodiments, the radiation attenuation layer forms a top exterior surface of the lid, and the fire suppression layer forms a bottom interior surface of the lid that is configured to face an internal volume of the laser crafting apparatus. In various embodiments, the radiation attenuation layer comprises at least one of a thermoplastic material and synthetic polymer, such as poly(methyl methacrylate). In various embodiments, the radiation attenuation layer is colored to attenuate transmission of electromagnetic radiation from a laser module of the laser crafting apparatus. In various embodiments, the fire suppression layer comprises a glass material, such as borosilicate glass.

In various embodiments, the lid further includes an intermediate spacer frame disposed between radiation attenuation layer and the fire suppression layer such that a gap is defined between the radiation attenuation layer and the fire suppression layer. In various embodiments, the radiation attenuation layer is at least one of adhered and bonded to an upper surface of the intermediate spacer frame. In various embodiments, the lid further includes a base frame having a bottom portion and a sidewall portion, wherein the intermediate spacer frame is coupled to the bottom portion of the base frame via a plurality of fasteners such that the fire suppression layer is securely retained and/or compressed between a lower surface of the intermediate spacer frame and an upper surface of the bottom portion of the base frame. A majority of the plurality of fasteners may be positioned outward of a periphery of the fire suppression layer such that the majority of the plurality of fasteners do not extend through the fire suppression layer. The intermediate spacer frame may have a plurality of tabs that extend downward around the periphery of the fire suppression layer and engage an upper surface of bottom portion of the base frame. In various embodiments, the plurality of tabs are only respectively disposed in a vicinity of the plurality of fasteners, and thereby the plurality of tabs prevent uneven cantilevering of the intermediate spacer frame in response to securement of the plurality of fasteners during manufacturing of the lid.

In various embodiments, the sidewall portion of the base frame at least partially surround a periphery of the intermediate spacer frame. An upper rim of the sidewall portion of the base frame faces a lower surface of the radiation attenuation layer, according to various embodiments. In various embodiments, the lid further includes a gasket frame disposed between a lower surface of the fire suppression layer and the upper surface of the bottom portion of the base frame. The gasket frame may include one or more ribs that extend upward from a periphery of the gasket frame and at least partially surround a periphery of the fire suppression layer. The one or more ribs may be disposed between the periphery of the fire suppression layer and the plurality of fasteners extending between the intermediate spacer frame and the bottom portion of the base frame. In various embodiments, the plurality of fasteners extend through the gasket frame.

The gasket frame may comprise a wrap-around lip that extends within an inner rim of the bottom portion of the base frame and extends back outward below the bottom portion of the base frame. The wrap-around lip may be made from a resiliently flexible material and may be configured to deform into engagement with an upper surface of a housing of the laser crafting apparatus in response to the lid being closed against the housing. In various embodiments, the fire suppression layer comprises outwardly extending wing portions, wherein respective pivoting arms of a hinge structure of the laser crafting apparatus are respectively coupled to the wing portions of the fire suppression layer. In various embodiments, the gasket frame comprises corresponding wing portions that extend between the outwardly extending wing portions of the fire suppression layer and the respective pivoting arms of the hinge structure of the laser crafting apparatus. In various embodiments, force transfer between the lid and the pivoting arms of the hinge structure of the laser crafting apparatus is via the fire suppression layer. In various embodiments, force transfer between the lid and one or more pivoting arms of a hinge structure of the laser crafting apparatus is exclusively via the fire suppression layer.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Thus, although the subject matter of the present disclosure is particularly pointed out and distinctly claimed in the concluding portion of the specification, a more complete understanding of the present disclosure, may best be obtained by referring to the detailed description and claims when considered in connection with the drawing figures. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1A is a top, front, right perspective view of a laser crafting apparatus in a closed configuration, in accordance with various embodiments;

FIG. 1B is a top, front, right perspective view of the laser crafting apparatus of FIG. 1A in an open configuration, in accordance with various embodiments;

FIG. 2A is a top, front, right perspective view of a laser crafting apparatus in a closed configuration, in accordance with various embodiments;

FIG. 2B is a top, front, right perspective view of the laser crafting apparatus of FIG. 2A in an open configuration, in accordance with various embodiments;

FIG. 2C is a perspective view of a rail assembly of a laser crafting apparatus, in accordance with various embodiments;

FIG. 3A is a perspective view of a laser carriage assembly of a laser crafting apparatus, in accordance with various embodiments;

FIG. 3B is a perspective view of the laser carriage assembly of FIG. 3A showing a fan cover removed, in accordance with various embodiments;

FIG. 3C is a perspective view of the laser carriage assembly of FIG. 3A showing a casing and a lens tray removed, in accordance with various embodiments;

FIG. 3D is a perspective view of the laser carriage assembly of FIG. 3A showing a fan and heat sink removed so a laser module is visible, in accordance with various embodiments;

FIG. 3E is a side cross-sectional view, along section E-E shown in FIG. 3A, of the laser carriage assembly of FIG. 3A, in accordance with various embodiments;

FIG. 3F is a bottom plan view of the laser carriage assembly of FIG. 3A, in accordance with various embodiments;

FIG. 3G is a perspective view of the laser carriage assembly of FIG. 3A showing a lens tray removed, in accordance with various embodiments;

FIG. 3H is a top perspective view of the lens tray of FIG. 3G, in accordance with various embodiments;

FIG. 4A is a top, front perspective view of a lid of a laser crafting apparatus, in accordance with various embodiments;

FIG. 4B is an exploded view of the lid of FIG. 4A, in accordance with various embodiments;

FIG. 4C is a cross-sectional view of the lid of FIG. 4A, in accordance with various embodiments;

FIG. 4D is another cross-sectional view of the lid of FIG. 4B, in accordance with various embodiments;

FIG. 5A is a side view of a hinge structure of a laser crafting apparatus in a closed configuration, showing a lid and a housing of the laser crafting apparatus in cross-section, in accordance with various embodiments;

FIG. 5B is a side view of the hinge structure of FIG. 5A in an open configuration, showing the lid in cross-section, in accordance with various embodiments;

FIG. 5C is a front view of the hinge structure of FIG. 5B, in accordance with various embodiments;

FIG. 6A is a bottom, rear, right perspective view of a laser crafting apparatus, in accordance with various embodiments;

FIG. 6B is a top, rear, right perspective view of the laser crafting apparatus of FIG. 6A (with a lid removed), in accordance with various embodiments;

FIG. 6C is a side cross-sectional view, along section C-C shown in FIG. 6A, of the laser crafting apparatus of FIG. 6A, in accordance with various embodiments;

FIG. 6D is a top, rear, left perspective view of a laser crafting apparatus showing a hose module attached, in accordance with various embodiments;

FIG. 6E is a top, rear, left perspective view of the laser crafting apparatus of FIG. 6D showing the hose module removed;

FIG. 6F is a perspective view of a hose module of a laser crafting apparatus, in accordance with various embodiments;

FIG. 6G is a perspective view of the hose module of FIG. 6F showing an interface plate partially removed, in accordance with various embodiments;

FIG. 6H is a perspective view of the hose module of FIG. 6G showing the interface plate fully removed, in accordance with various embodiments;

FIG. 6I is a perspective view of a window vent, in accordance with various embodiments;

FIG. 7A is a top perspective view of a material support tray and a retention clip, in accordance with various embodiments;

FIG. 7B is a side cross-sectional view of the material support tray, a material mat, and the retention clip of FIG. 7A shown in both a removed and installed state, in accordance with various embodiments;

FIG. 7D is a bottom plan view of the material support tray of FIG. 7A, in accordance with various embodiments; and

FIG. 8 is a schematic depiction of a computing system for controlling a laser crafting apparatus, in accordance with various embodiments.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the disclosure, other embodiments may be realized and logical changes and adaptations in design and construction may be made in accordance with this disclosure without departing from the spirit and scope of the disclosure. Thus, the detailed description herein is presented for purposes of illustration only and not of limitation.

Disclosed herein, according to various embodiments, are laser crafting apparatuses, systems, and methods. Although numerous details and examples are included herein pertaining to laser devices and associated systems and methods in the crafting industry, the present disclosure is not necessarily so limited, and thus aspects of the disclosed embodiments may be adapted for utility and/or operation in a variety of other non-crafting industries. As such, numerous applications of the present disclosure may be realized.

The laser crafting apparatuses, systems, and methods disclosed herein provide various benefits over conventional laser cutting machines. Although many exemplary benefits are explicitly highlighted and identified herein, other benefits and/or technical effects may not be explicitly called out but are nevertheless contemplated by the present disclosure. For example, at least one aspect of the present disclosure provides a laser crafting apparatus having a lid and/or hinge structure that provides substantially unhindered user access to the interior, working portion of the laser crafting apparatus. Even if such a benefit or technical effect had not been positively identified herein, such a benefit and/or technical effect would be readily apparent to the reader of this disclosure, and thus such a benefit and/or technical effect would have fallen within the scope of the disclosure.

Generally, the laser crafting apparatus disclosed herein is a computer-numerically-controlled machine configured to direct energy (e.g., electromagnetic radiation along a beam axis, also generally referred to as a laser beam) at a workpiece for the purpose of affecting a change in or otherwise altering the material, according to various embodiments. For example, the laser crafting apparatus may direct electromagnetic radiation toward the workpiece in order to cut, engrave, burn, raster, or otherwise impart a design effect upon the workpiece. The laser energy can be absorbed by the material to discolor, ablate, burn, melt, vaporize, etc., and/or the laser energy can be utilized to form holes, cuts, engravings, and the like. The laser energy can also cause the material of the workpiece to harden, cause a phase transition, or otherwise modify the physical characteristics of the workpiece. The laser beam may be focused so that a maximum power density is achieved at the material.

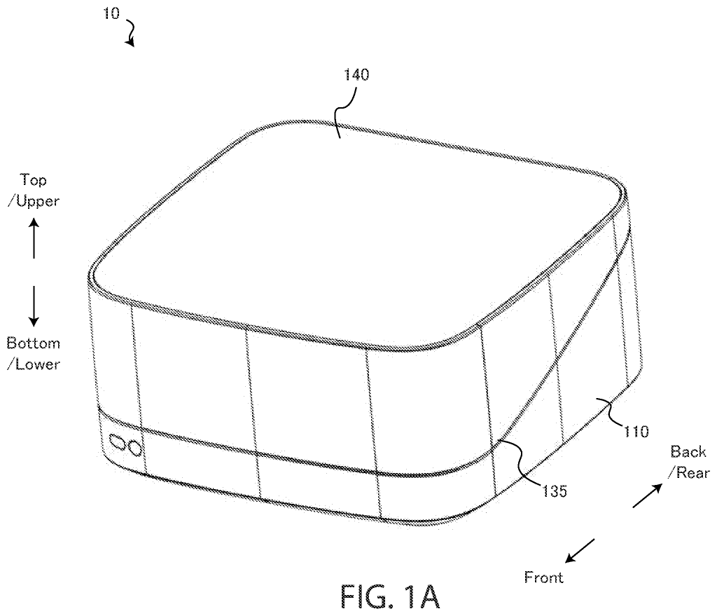

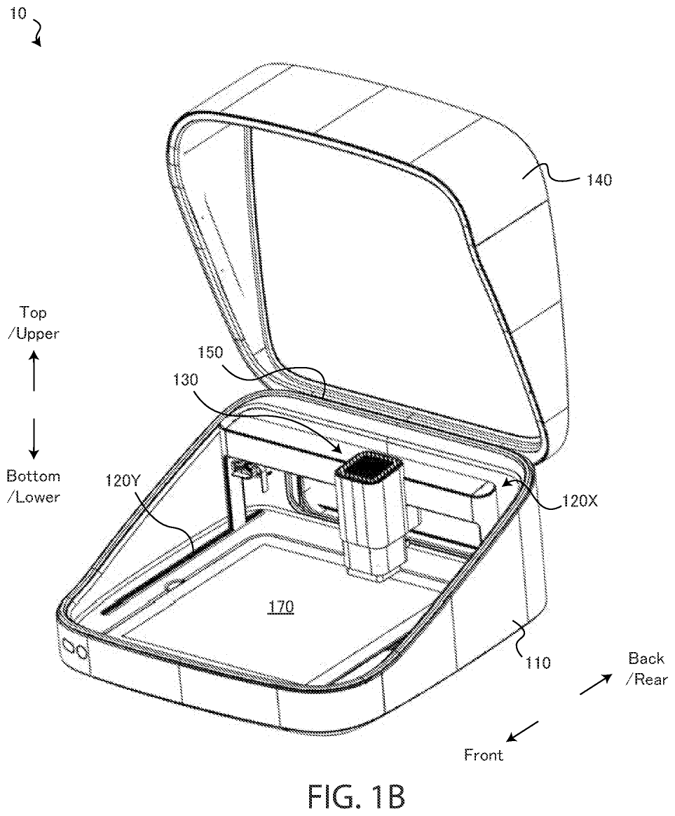

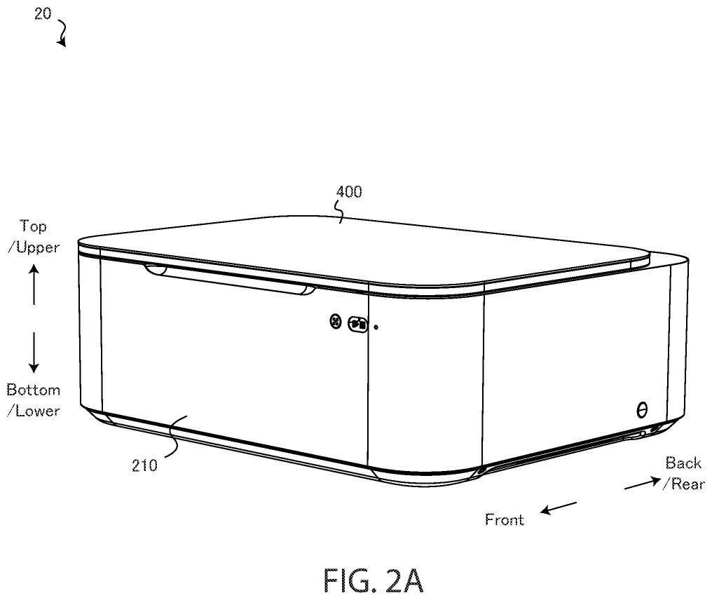

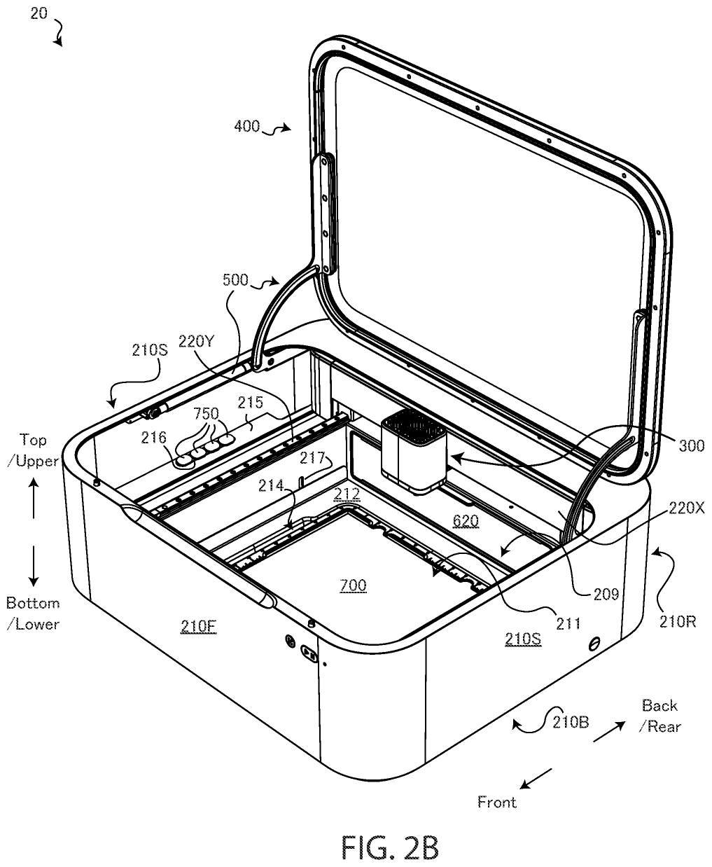

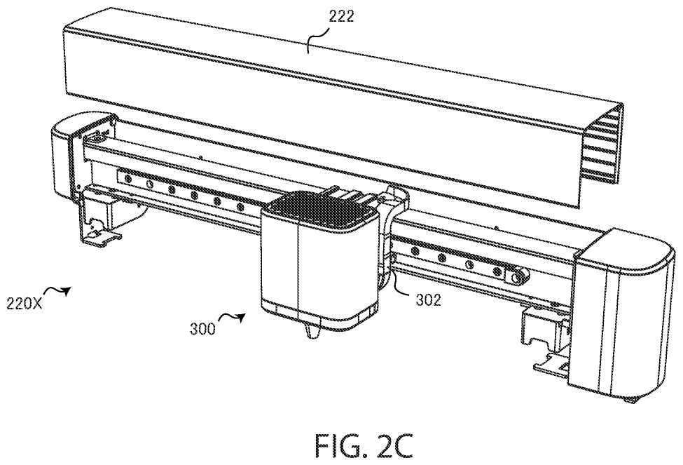

Turning now to the figures, FIGS. 1A, 1B, 2A, 2B, and 2C provide various views of various embodiments and implementations of a laser crafting apparatus 10, 20. For example, FIGS. 1A and 1B illustrate a first embodiment of a laser crafting apparatus 10 in a closed configuration and an open configuration, respectively, while FIGS. 2A and 2B illustrate a second embodiment of a laser crafting apparatus 20 in a closed configuration and an open configuration, respectively. The laser crafting apparatus disclosed herein may take various forms, may have various exterior shapes, and/or may have various component configurations and structures, as is apparent from the contrasting implementations illustrated in FIGS. 1A, 1B, 2A, and 2B. For example, the type, strength, and/or size of the various components (e.g., the laser module) may vary from one embodiment to another. Further, the dimensions and the working area of the apparatus may also vary between embodiments without departing from the spirit of embodiments shown and described herein. Accordingly, various details described in association with one or more embodiments depicted in the figures may be used in conjunction with other depicted implementations. Indeed, while many details and examples are included herein specifically pertaining to the form of the laser crafting apparatus 20 depicted in FIGS. 2A and 2B, the scope of the present disclosure is not necessarily so limited.

In various embodiments, and with reference to FIGS. 1A and 1B, the laser crafting apparatus 10 includes a housing 110 and a lid 140 pivotably coupled to the housing 110 (e.g., at hinged connection 150). Said differently, the lid 140 can be selectively opened and closed by rotating the lid 140 relative to the housing 110 at hinged connection 150. FIG. 1A illustrates the laser crafting apparatus 10 in a closed configuration and FIG. 1B illustrates the laser crafting apparatus in an open configuration, according to various embodiments. In the closed configuration shown in FIG. 1A, a borderline 135 is defined as the interface/junction where the lid 140 and the housing 110 meet when the apparatus is in the closed configuration, according to various embodiments. The illustrated borderline 135 represents the shape of the lower rim of the lid 140 and the upper rim of the housing 110, such that, when in the open configuration seen in FIG. 1B, the front wall of the housing 110 is lower than the rear wall of the housing 110, according to various embodiments. In such a configuration, a user may have easy access to the workspace region (e.g., the region where a material support tray 170 is disposed), as the height of the front wall of the housing 110 is so low, thereby enabling the user to easily insert, remove, and/or manipulate workpieces and other materials within the workspace region, and/or to otherwise manipulate, inspect, clean, or otherwise interact with the components of the laser crafting apparatus 10, such as the laser carriage assembly 130 and or the rail assemblies 120X, 120Y. Further, the rear wall may be higher than the front wall to provide sufficient space to enclose and accommodate the necessary mechanical structure of the laser crafting apparatus 10, as will be described in greater detail herein.

Throughout the present disclosure, positional terms such as top, upper, bottom, lower, front, forward, back, rear, interior, exterior, and the like, are used to describe various components and/or various sections, segments, and/or portions of components and structures. These terms are not meant to describe absolute positions, but instead these terms are used to describe shapes and geometries of various components relative to a user's perspective and experience during standard engagement and utilization of the disclosed apparatuses, systems, and methods. To provide further clarity and relativity, the figure views are repeatedly labeled with a top and bottom axis (e.g., an upper and lower axis) and/or a front and back axis (e.g., a forward and rear axis) to depict this ‘standard’ perspective relative to which the components of the laser crafting apparatus 10, 20 are described.

In various embodiments, and with continued reference to FIGS. 1A and 1B, the laser crafting apparatus 10 includes mechanisms and components to drive and/or move a laser, such as a laser carried by carriage 130, above and coplanar with a working surface. The working surface may be a support surface, such as material support tray 170, disposed in a bed or a floor of the laser crafting apparatus 10. The material support tray 170 may be a surface upon which one or more workpieces may be placed for alteration, and towards which electromagnetic radiation from the laser is emitted. The laser crafting apparatus 10 may include drive components, such as rails (e.g., rail 120X and rail 120Y, generally referred to herein as rail assemblies), belts, gears, electronic cables, wires, motors, cooling systems, and the like.

Therefore, the drive mechanisms and components of the laser crafting apparatus may be configured to drive the laser mounted to carriage 130 above and around/across the full length and width above the material support tray 170 so the laser can be positioned over any point above the working surface of the material support tray 170.

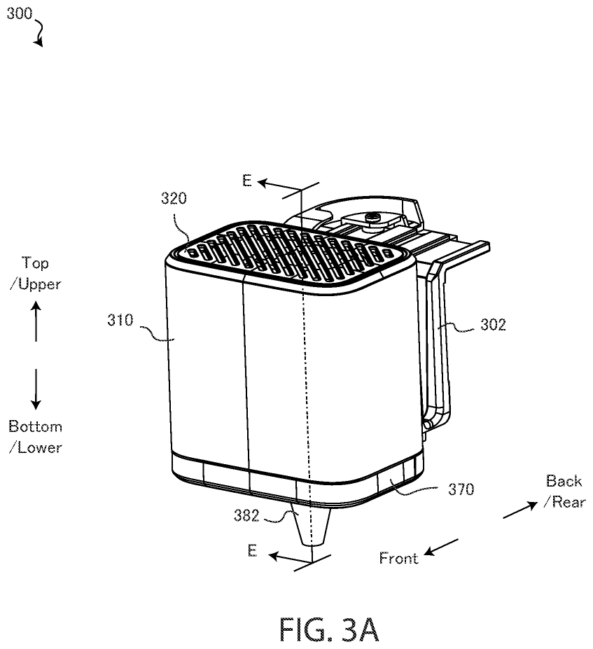

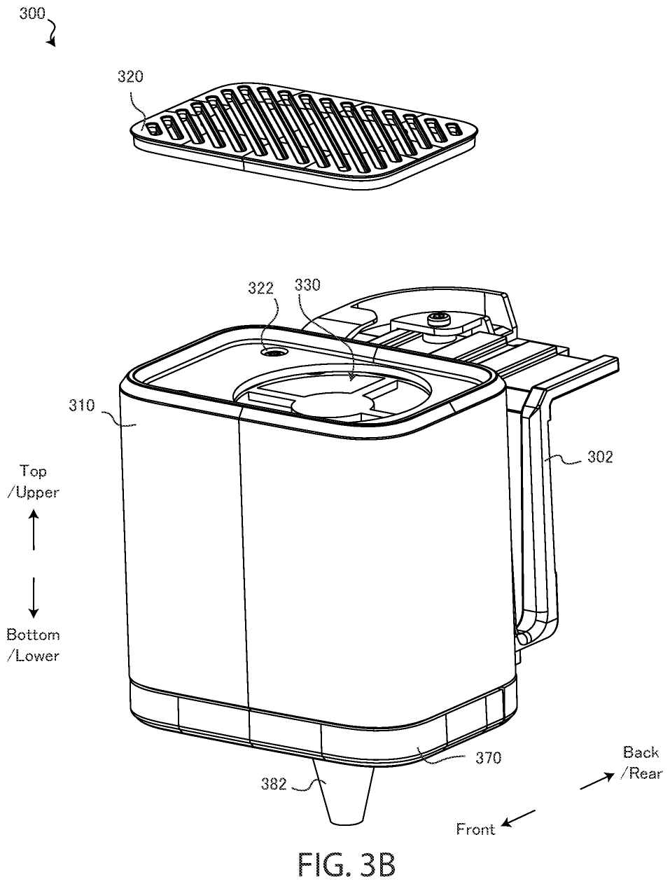

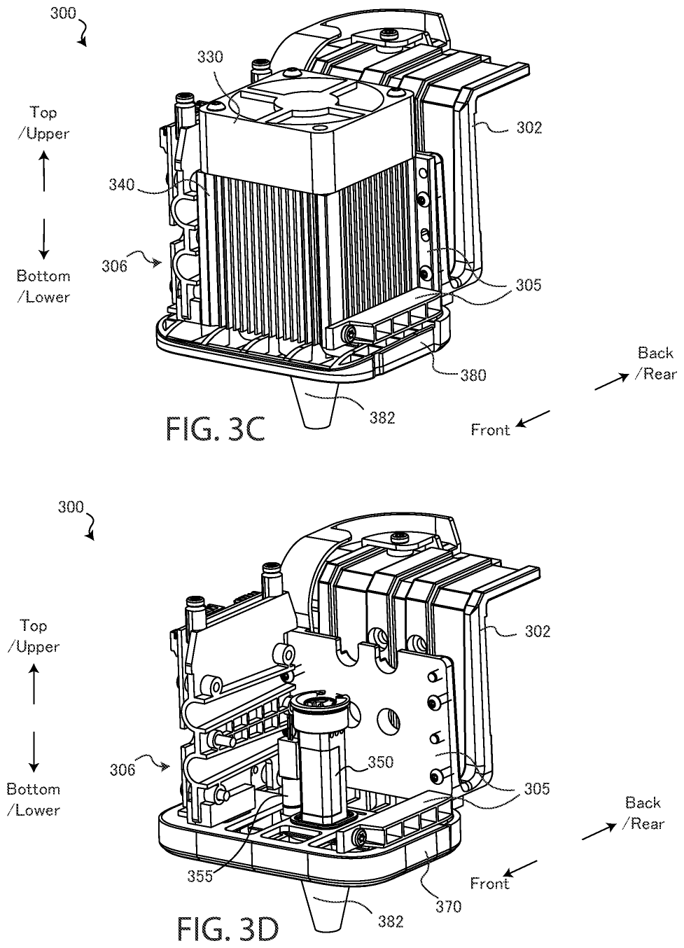

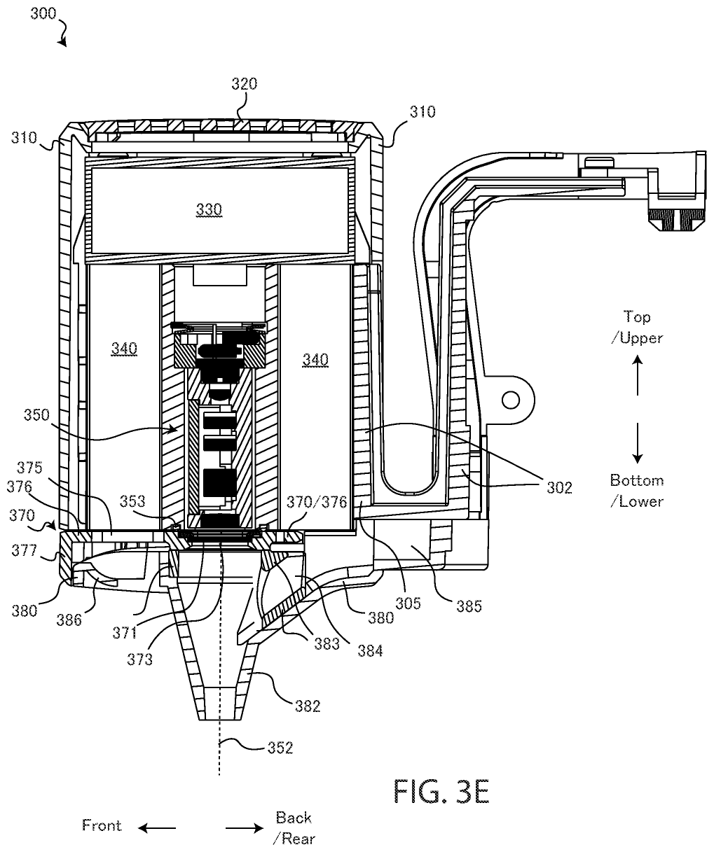

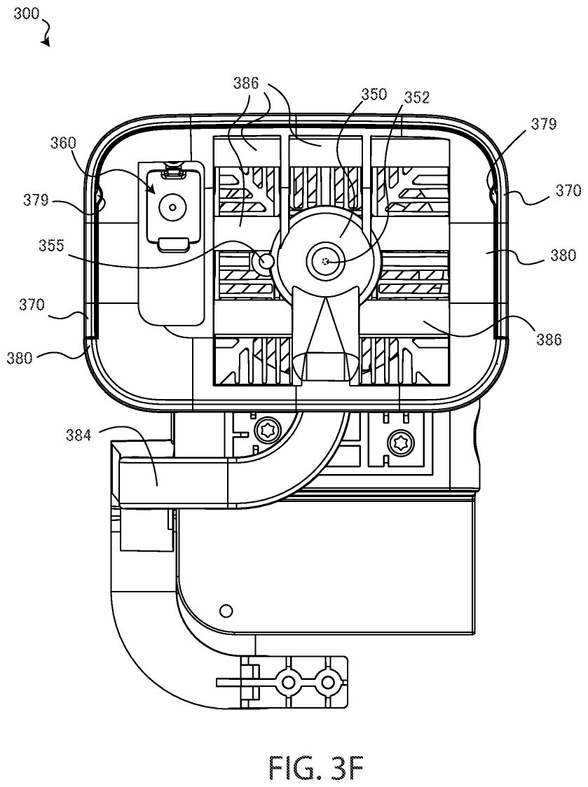

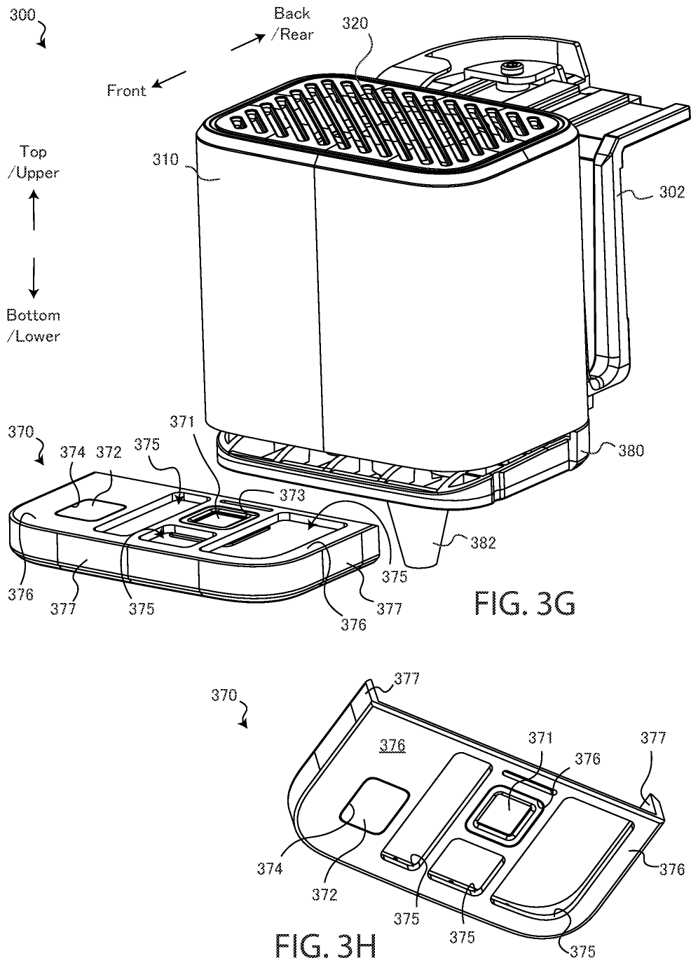

In various embodiments, not only may the front face of the housing 110 be lower enough to provide improved and/or unhindered access to the material support tray 170, but the carriage 130 and drive components may also be positioned such that none of the drive components interfere with a user reaching into the machine when in the open configuration. Said differently, the drive components may be disposed under housing panels and/or within rail covers (e.g., rail cover 222 in FIG. 3C) such that the laser crafting apparatus 10 is configured to prevent a user's finger from being inserted into the drive components.

In various embodiments, carriage 130 may be moveably (e.g., slidably) coupled to rail 120X, and rail 120X may be close to a rear wall of the housing 110 and/or lid 140. The laser crafting apparatus 10 may be configured to controllably move carriage 130 back-and-forth in an X-direction. In various embodiments, rail 120X may extend all or nearly all of the width of internal volume of the laser crafting apparatus 10. In various embodiments, an X-drive motor may be configured to drive movement of the carriage 130 on the X-rail 120X. In various embodiments, the X-rail 120X may be suspended above the material support tray 170 via one or more vertical posts. The vertical posts may ride along one or more Y-rails 120Y to enable Y-direction movement of the carriage 130 and thus the laser module mounted to the carriage. As used herein, the term X-direction and the like refer to side-to-side, lateral movement along the rail to which the carriage 130 is coupled, and the term Y-direction and the like refer to forward and rearward movement. In various embodiments, the vertical posts of the X0rail 120X may extend below the working surface via slots. The Y-drive components may similarly be disposed below the working surface or may be disposed below and/or within an elevated panel forming a shelf adjacent the working surface. Additionally, or alternatively, in various embodiments the Y-drive components may be situated below and/or to one or more sides of the working surface so that Y-drive components likewise do not hinder a user's hand from accessing the working surface from the top, front, or either side of machine when the lid 140 is open.

Regarding the Z-direction movement, or the up-and-down movement, the carriage 130 itself may articulate up-and-down relative to the X-rail 120X via one or more motors and vertical rails. However, in various embodiments the working surface and/or the bed of the apparatus (e.g., the material support tray 170) is configured to be raised and lowered, thereby creating the achieving the aforementioned “up-and-down” movement of the laser module relative to the workpiece.

In various embodiments, and turning now to reference FIGS. 2A, 2B, and 2C, additional details of the laser crafting apparatus 20 are provided. The laser crafting apparatus described with reference to FIGS. 2A, 2B, and 2C may include various components, such as rail assemblies 220X, 220Y, a laser carriage assembly 300, a lid 400, a hinge structure 500, and/or a material support tray 700. These components and assemblies may be similar to the corresponding components 120X, 120Y, 130, 140, 150, and 170, respectively, of FIGS. 1A and 1B. Thus, various details from one implementation may be utilized in the other implementation, and vice-versa. Indeed, details from the various embodiments may be combined with details from other embodiments unless explicitly or implicitly described otherwise herein.

In various embodiments, the laser crafting apparatus 20 includes a housing 210 and a lid 400 pivotably coupled to the housing 210 (e.g., via a hinge structure 500). The lid 400 can be rotated between a closed and an open position, thus allowing the laser crafting apparatus to toggle between the closed configuration of FIG. 2A and the open configuration of FIG. 2B. The housing 210 and the lid 400 may collectively (and at least partially) define an internal volume 209 of the laser crafting apparatus 20. Said differently, the housing 210 may provide four walls and a floor of the internal volume 209 and the lid 400 may provide the openable ceiling of the internal volume 209. In various embodiments, when the laser crafting apparatus is in the closed position (FIG. 2A), harmful electromagnetic radiation from the laser module 350 (FIG. 3D) is prevented or at least substantially inhibited from inadvertently escaping the internal volume 209, as described in greater detail below.

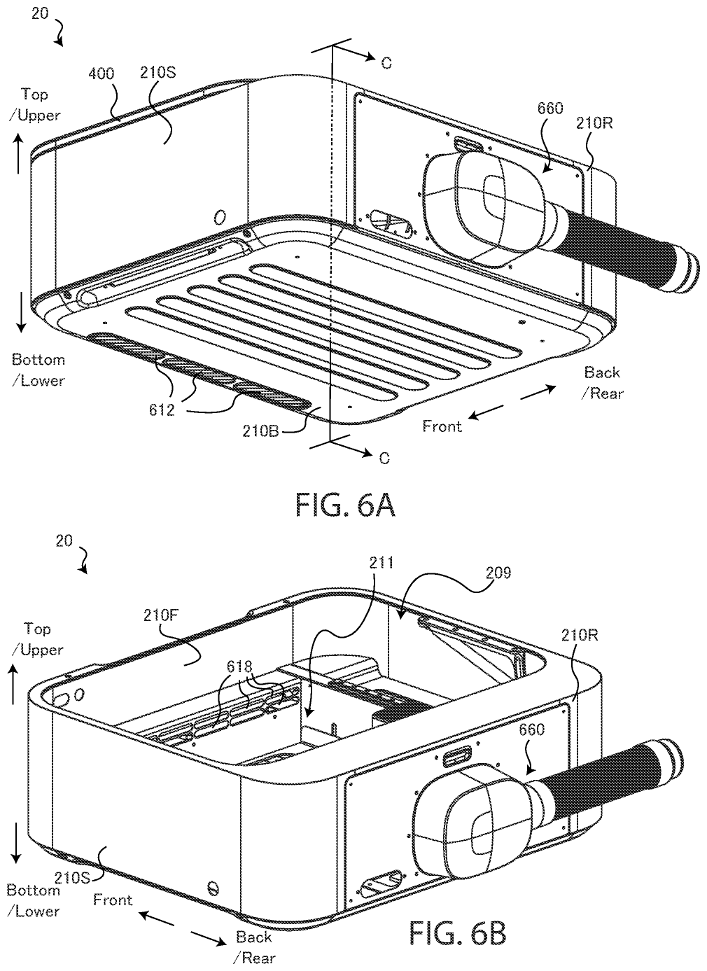

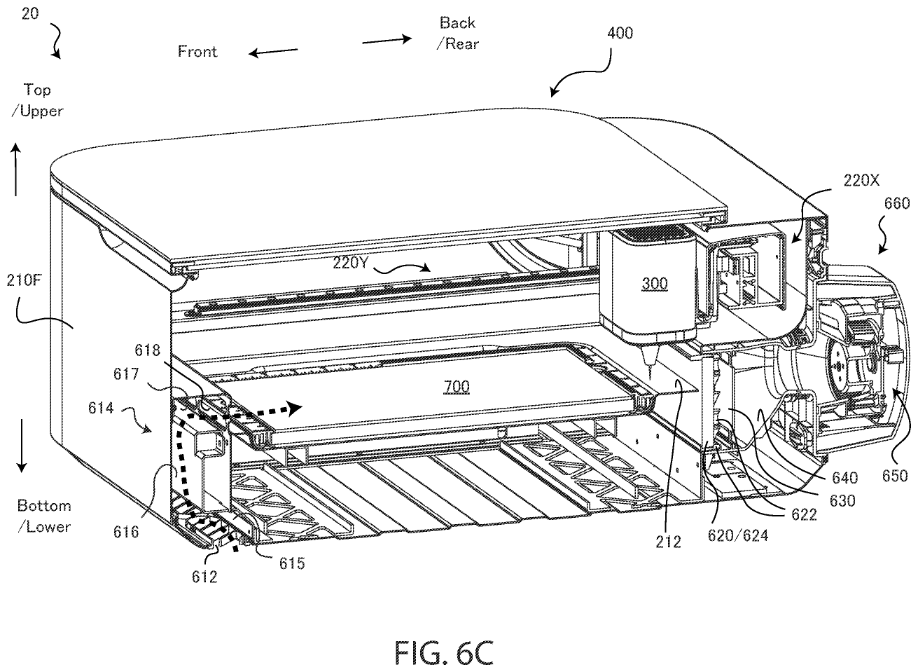

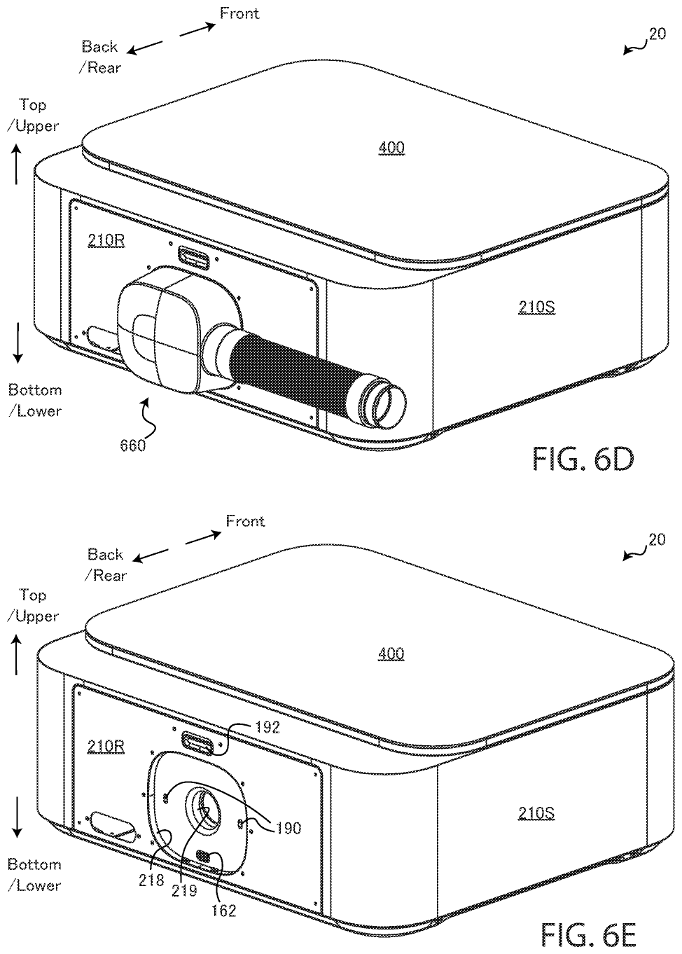

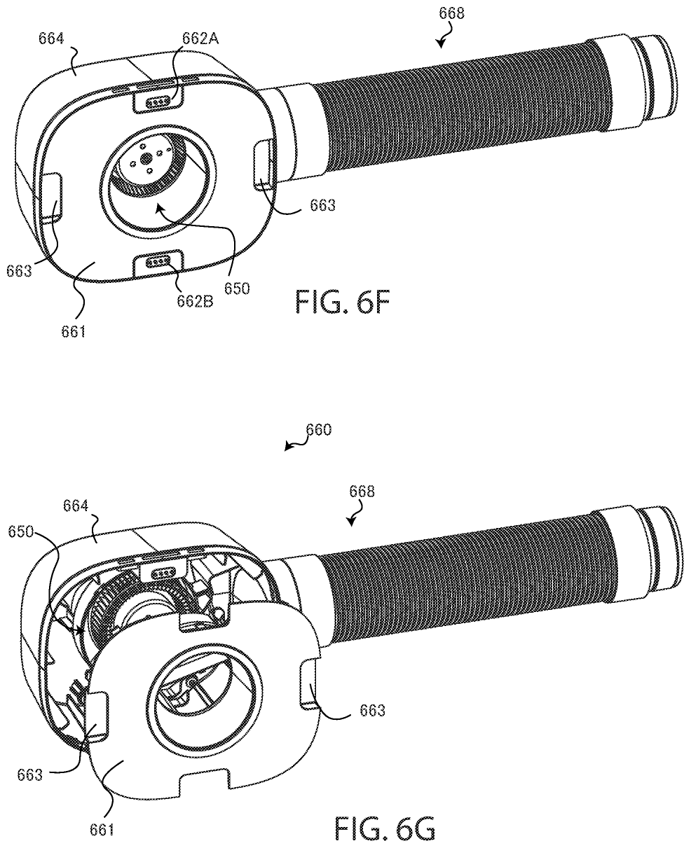

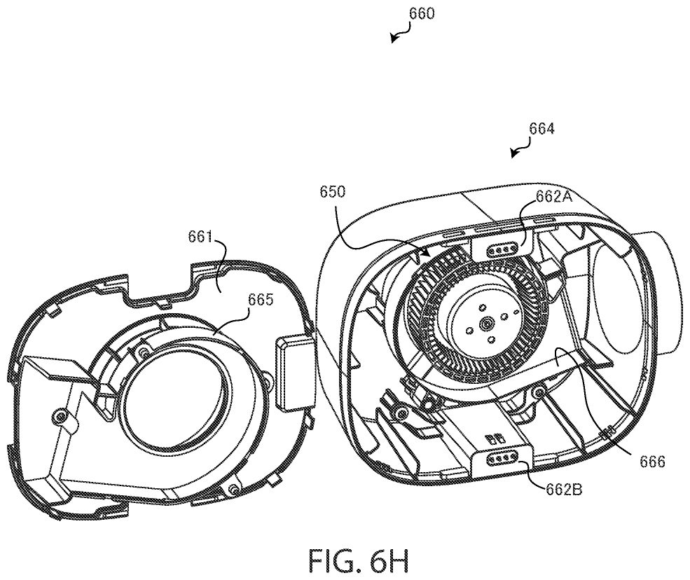

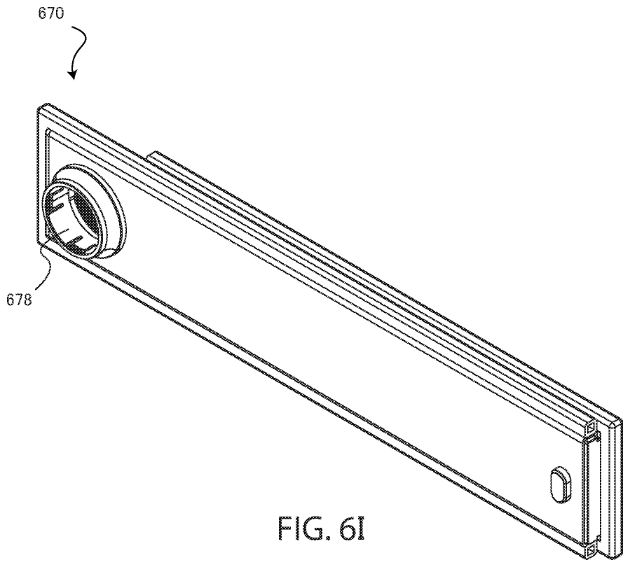

The housing 210 may include a front panel 210F, opposing lateral side panels 210S, and a rear panel 210R opposite the front panel 210F. The housing 210 may also include a bottom panel 210B. The housing 210 generally comprises the structural members, the cosmetic casings, and both the interior and/or exterior facing sections and paneling of the laser crafting apparatus 20. Accordingly, although various figures may appear to only indicate and label exterior panels with the reference numbers for the housing, the housing may generally comprise and provide the structural framework and support for the components described below, and thus the term “housing” may refer to more components and features than what is shown in the figures. For example, the front panel 210F of the housing 210 may include multiple layers and panels of “wall” material and/or may define multiple plenums 615, 616, 617 (see FIG. 6C), channels, or chambers.

In various embodiments, and with reference to FIGS. 2B and 2C, the laser crafting apparatus 20 includes a laser carriage assembly 300 coupled to a rail assembly that is mounted to the housing 210. The laser carriage assembly 300 may include a laser module 350 (see FIG. 3D) configured to emit electromagnetic radiation, and the laser crafting apparatus 20 may be configured to drive/move the laser carriage assembly along the rail assembly within the internal volume 209. Said differently, the laser crafting apparatus 20 may include, or may be coupled in control communication with, one or more controllers and/or processors that actuate movement of the laser carriage assembly 300 along the rail assembly relative to a workpiece disposed within the internal volume of the housing 210. The rail assembly may include, for example, an X-rail 220X and a Y-rail 220Y. As introduced above, the laser carriage assembly 300 may be moveably (e.g., slidably) coupled to the X-rail 220X, and the X-rail 220X may be moveably (e.g., slidably) coupled to one or more Y-rails 220Y. Thus, lateral, side-to-side movement of the laser carriage assembly 300 may be achieved along the X-rail 220X and forward-and-backward movement of the carriage assembly 300 may be achieved along the one or more Y-rails 220Y. The laser crafting apparatus 20 may also include a lift mechanism 217 to achieve Z-direction (vertical, up-and-down) movement of the workpiece relative to the laser. Reference numeral 217 in FIG. 2B points to a slit in a panel, and the lift mechanism, which may include one or more lead screws or other vertical translation mechanisms, may be disposed behind this (and other) panels. The vertical lift mechanism 217 may be coupled to a workspace bed 212 and may be configured to raise and lower the workspace bed 212 within the internal volume 209 of the laser crafting apparatus 20.

In various embodiments, the rail assemblies, lift mechanism(s), the drive components, and the laser carriage assembly 300 are disposed within the internal volume 209 collectively defined by the housing 210 and the lid 400. The term “workspace region” 211 used herein refers to a portion or sub-zone of the larger the internal volume 209 and is specifically used to indicate the effective working area of the laser crafting apparatus 20. That is, the workspace region 211 refers to the volume of space directly above a material support tray 700 and below the laser carriage assembly 300 (e.g., below the position of the focal point of the emitted electromagnetic laser radiation) and is defined as the space within which laser operations/work can be performed on a workpiece.

In various embodiments, the laser crafting apparatus includes the material support tray 700 mentioned above. The material support tray 700 may be supported within the internal volume 209 of the laser crafting apparatus 20. For example, the housing 210 (e.g., the bottom panel 210B of the housing 210) may comprise a workspace bed 212 that is configured to receive, engage, support, and/or otherwise retain the material support tray 700 in a known loaded position relative to the rail assemblies within the internal volume 209. The workspace bed 212, which may be raised and lowered using the lifting mechanism 217, may define a nested region 214 that is configured to receive the material support tray 700 at least partially therewithin.

In various embodiments, the material support tray 700 is removable, and thus the material support tray 700 may be removably/detachably supported on the workspace bed 212. For example, the material support tray 700 may be reversibly/removably seated against the workspace bed 12. Said differently, in various embodiments the material support tray 700 can be removed by a user from the internal volume of the laser crafting apparatus 20 to allow for the user to easily situate a workpiece on the material support tray 700. With the material support tray 700 removed from the internal volume 209, the user may have substantially unhindered access to properly position, situate, and couple one or more workpieces on the material support tray 700 before returning the material support tray 700 to the internal volume 209. Also, some working materials are delicate and fragile after being worked upon by the laser, and thus it may be advantageous to remove the material support tray 700 from the internal volume 209 of the laser crafting apparatus 20 22 with the workpiece still supported on the material support tray 700 after the operation has been performed on the workpiece. Further, over time the material support tray 700 or various other internal components may deteriorate may need to be cleaned and/or replaced. The removable configuration of the material support tray 700 allows a user to easily remove, replace, clean, and otherwise perform maintenance on the laser crafting apparatus 20.

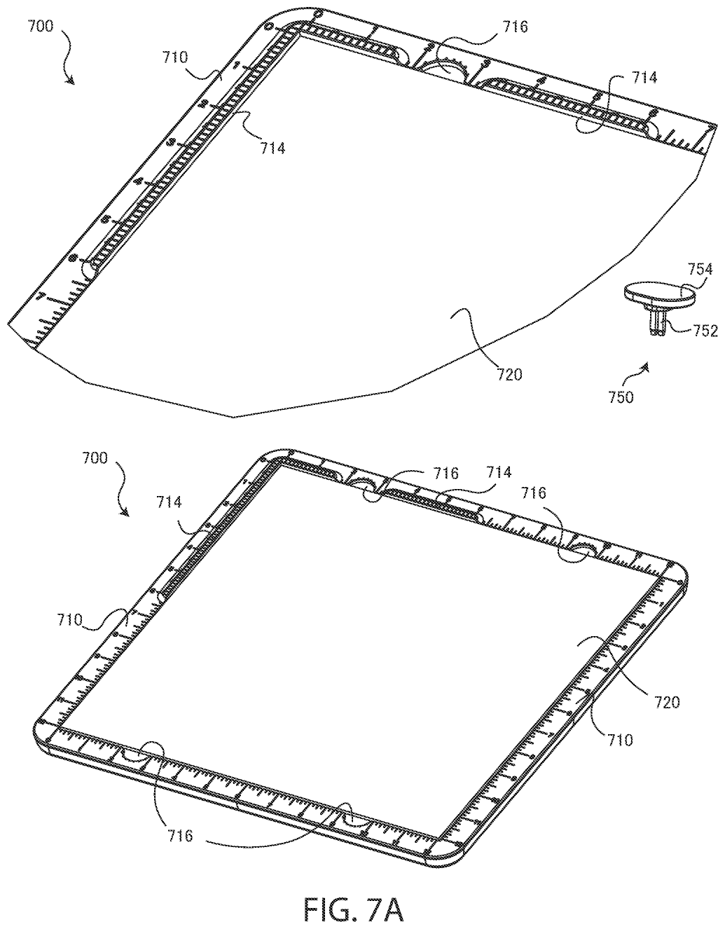

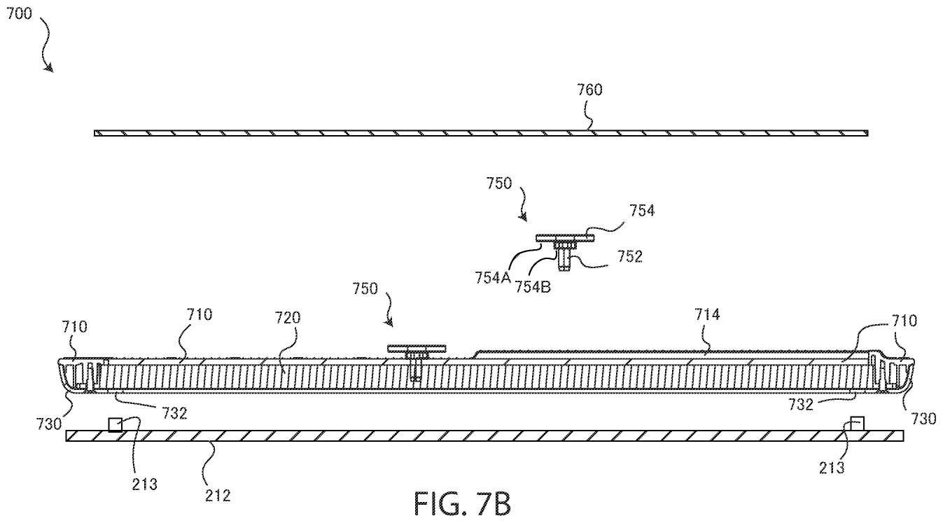

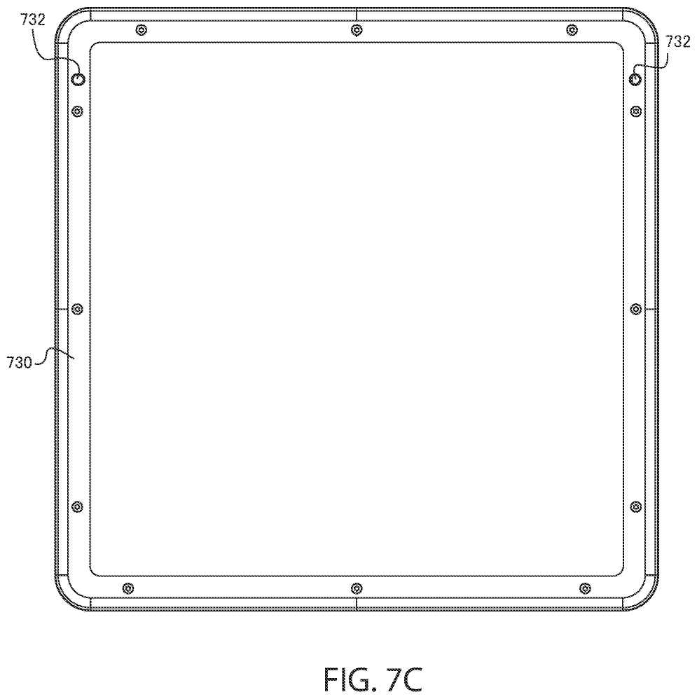

FIGS. 7A, 7B, and 7C provide various views of an exemplary material support tray 700, in accordance with various embodiments. The material support tray 700 may include a rigid mesh body 720 for supporting the workpieces thereon. The rigid mesh body 720 may define a plurality of cells. For example, the rigid mesh body 720 may have a honeycomb structure, comprising a plurality of hexagonal cells. The cells of the rigid mesh body 720, according to various embodiments, generally extend in a vertical direction, perpendicular to the plane of the material support tray 700. The rigid mesh body 720 may be made from a metallic material, such as aluminum, steel, or other ferrous materials.

The material support tray 700 may also include one or more features, structures, and/or sub-assemblies that provide for workpiece alignment and proper positioning and orienting of the workpiece upon the rigid mesh body 720. Further, the material support tray 700 may comprise an assembly or a kit that includes a plurality of associated components for reversibly holding, retaining, fixing, attaching, coupling, and/or otherwise securing one or more workpieces on the material support tray 700 during a crafting operation performed on the workpiece. For example, one or more retention clips 750 may be included with the laser crafting apparatus 20, and each retention clip 750 may be configured to detachably couple to the rigid mesh body 720 of the material support tray 700 to facilitate securement of one or more workpieces to the material support tray 700.

In various embodiments, the retention clip 750 comprises a stem portion 752 and a cap portion 754. The stem portion 752 may include a plurality of pins configured to extend at least partially within the cells of the rigid mesh body 720. The plurality of pins of the stem portion 752 may be parallel to each other, and may be sized and slightly distributed apart from each other so as to enable each pin to be inserted into a respective cell, via a resistance or interference fit, of the rigid mesh body 720 of the material support tray 700. For example, the rigid mesh body 720 may comprise a hexagonal mesh, and the pins of the stem portion 752, which may include three pins, may be distributed in a hexagonal pattern relative to each other to conform with the complementary pattern of the hexagonal mesh. In various embodiments, and with momentary reference to FIG. 2B, the housing 210 of the laser crafting apparatus 20 may have a shelf 215 or other surface within the internal volume 209 that is configured to retain and/or support the one or more retention clips 750 when not in use for workpiece securement. For example, the shelf 215 may define a slot 216, and the stem portions 752 of the retention clips 750 may be received into the slot 216 to stow the retention clips 750 when not in use.

In various embodiments, and returning to reference FIGS. 7A, 7B, and 7C, the cap portion 754 of the retention clip 750 may be configured to engage a top, edge, or flange surface of a workpiece, thereby sandwiching at least a portion of the workpiece between the cap portion 754 and the rigid mesh body 720 of the material support tray 700. In various embodiments, the cap portion 754 defines two shoulders 754A, 754B (e.g., two lower flat surfaces) at different heights relative to the overall height of the retention clip 750. In other words, the cap portion 754 may be able to facilitate securement of workpieces of different thickness by allowing the user to select which shoulder 754A, 754B to use as the contact/engagement surface against the workpiece.

In various embodiments, the material support tray 700 and/or the laser crafting apparatus 20 may include other types of workpiece retainers, such as jigs, straight fences, curved fences, or the like. These workpiece retainers, similar to the retention clip(s) 750, may be removable and reconfigurable to provide boundaries or guides for placing workpieces or other materials onto the material support tray 700. For example, jigs having 90-degree angles for bounding a square or rectangle of space on the material support tray 700 may be utilized. In various embodiments, one, two, or more than two jigs may be used in combination to provide guides for materials placed on the material support tray 700.

In various embodiments, workpiece retainers may incorporate magnets to be magnetically reversibly secured to the material support tray (e.g., a magnetic metallic material forming the rigid mesh body 720). In such a configuration, the workpiece retainers may be easily removed, replaced, and reconfigured as needed by the user. One or more other attachment mechanisms may also be incorporated into the workpiece retainers to removably them to the material support tray 700. In various embodiments, friction engagement between the workpiece retainers and the material support tray 700 may be sufficient to maintain the workpiece retainers in place.

In various embodiments, and with specific reference to FIG. 7B, the material support tray 700 may include mat 760 extending across a top surface of the material support tray 700. The mat 760, shown schematically in FIG. 7B, may itself be removable from the material support tray 700. Similar to the aforementioned benefits of the removable tray, by having a removable mat 760 on a removable tray 700, the flexibility, manipulability, and ease of use for the user may be further augmented. In various embodiments, the mat 760 may have gridlines and/or other guidance marks that are durable against electromagnetic energy emitted by the laser module during operation. In various embodiments, the mat 760 includes one or more recesses for at least partially receiving a portion or section of a workpiece. For example, the mat 760 may include a circular recess for positioning a circular working material, such as a coaster, within the recess. In such a configuration, a user may easily place the workpiece in the correct position on mat 760 that corresponds with a position in a design software user-interface grid or virtual mat. Such a coaster, or other circular workpiece may be manufactured to specifically fit within the recess of the mat 760. Any number or shapes of recesses may be added to the mat 760 in one or more other embodiments to accommodate any number or combinations of correspondingly shaped working material pieces.

In addition, various embodiments of the mat 760 may include an identification code, tag, chip, or other identification means. This identification means may be configured to facilitate an identification, or auto-identification, of the specific mat 760 loaded into the apparatus. In this way, by simply placing the 760 within the laser crafting apparatus 20, the laser crafting apparatus 20 may automatically detect the specific mat 760 (and/or the user may manually scan or enter in a mat identifier), and the laser crafting apparatus 20 may adjust the settings of the laser module 350 or other components to optimally cut the workpiece that corresponds to the specific mat 760. Said differently, an identification means associated with the mat 760 may be associated with a specific recess or combination of recesses so that the apparatus 20 auto-detects which 760 is inserted therein, thus identifying which materials can be placed on mat 760 based on those recesses. The lasing settings of the apparatus, and/or other settings such as carriage movement settings etc., can then be auto-adjusted accordingly for optimal work on those materials. The above details pertaining to specific mats and/or specific recesses may also be applicable to the trays themselves. That is, the laser crafting apparatus 20 may include multiple material support trays, or different material support trays that are specifically tailored to support specific workpieces may be utilized in the apparatus, thus allowing for the aforementioned process efficiencies pertaining to settings and process parameter adjustments based on the workpiece to be worked upon.

In addition, or alternatively, the laser crafting apparatus 20 may include other light sources, such as a visible light source 355 (FIG. 3D), or the laser module 350 may be operable in alternative modes to project a non-material altering guidance/crosshair pattern onto the material support tray 700. Such a guidance pattern may take any number of forms that are helpful in assisting a user in visually identifying the bounds of a pattern in design software. Using a virtual mat in the user-interface of a design software, the software may communicate the position of the designed pattern to the laser crafting apparatus 20. The guidance pattern can then be projected onto the material support tray 700 and/or directly onto a workpiece to visually show the user where the bounds of the design will be. The user can use the guidance pattern/crosshairs to make sure the workpiece is properly placed to have the design properly cut or engraved on the working material.

In various embodiments, the material support tray 700 includes a frame extending around a periphery of the rigid mesh body 720. For example, the material support tray 700 may include an upper frame 710 and/or a lower frame 730. The upper frame 710 may be coupled to the lower frame 730 with the rigid mesh body 720 sandwiched therebetween. The upper frame 710 may include a raised rib portion 714 (also referred to herein as a raised fence portion or a raised guide wall portion) extending upward from the upper frame 710. The raised rib portion may extend at least partially around the rigid mesh body 720. The raised rib portion 714 may facilitate proper placement of mats 760 and/or workpieces upon the tray. That is, a material may be placed onto the material support tray 700 and situated against the raised rib portion, thus enabling the user to consistently and repeatedly position material relative to a corner (i.e., a “zero-zero” corner) of a coordinate system of the tray. For example, the raised rib portion 714 may extend at least partially across two borders of the upper frame 710 to form a right angle.

In various embodiments, the upper frame 710 may also include alignment features, guidance features, and/or measurement features disposed on an upper surface of the upper frame 710 to facilitate alignment and positioning of the workpiece upon the material support tray 700. The alignment/guidance features of the frame may be referenced by the user when comparing a desired design in a software program. That is, a user may reference the guidance features on the frame, which may correspond to a grid or other coordinate system in the design software, to place the design and/or workpiece in the same position on the tray 700 to achieve the desired design.

In various embodiments, the workspace bed 212, which is schematically depicted in FIG. 7B, includes a plurality of upwardly extending keying pins 213 and the material support tray 700 includes a plurality of keying recesses 732 (e.g., defined in a lower frame 730, as shown in FIGS. 7B and 7C). The plurality of keying recesses 732 may be configured to align with and respectively receive the plurality of upwardly extending keying pins 213 to facilitate consistent and repeatable loading of the material support tray 700 in the known loaded position. Thus, the corresponding keying features between the removable material support tray 700 and the workspace bed 212 may function as datums to facilitate proper relative alignment and to ensure proper seating of the tray 700 into the laser crafting apparatus 20.

One or more sets of the corresponding keying features 213, 732 may have different and/or non-circular shapes, thus only allowing the material support tray 700 to be seated on the workspace bed 212 in a correct orientation. For example, one of the keying recesses 732 may have an oblong shape (e.g., keying recess 732 shown on left side of FIG. 7C) and/or one of the keying recesses may have a flat/planar surface section (e.g., keying recess 732 shown on the right side of FIG. 7C), with respective keying pins 213 having a conforming/complementary shape. In various embodiments, the material support tray 700 may be exclusively supported by the corresponding keying features 213, 732. Said differently, the surfaces of the workspace bed 212 (e.g., the surfaces that define the nested region 214) may not directly contact and support the material support tray 700 when the material support tray 700 is properly seated within the apparatus 20. By having such a configuration, all the surfaces that form the workspace bed 212 need not be precisely keyed, but instead only the keying pins 213 may need to be properly and precisely keyed.

In various embodiments, and with reference to FIGS. 3A, 3B, 3C, 3D, 3E, 3F, 3G, and 3H, additional details pertaining to a laser carriage assembly 300 are provided. The laser carriage assembly 300 may include a support structure 305 and a laser module 350 mounted to the support structure 305. As mentioned, the laser module 350 may be configured to emit electromagnetic radiation along a beam axis 352 toward a workpiece. The support structure 305 may include, or may be coupled to, connecting structure 302 that extends to a rail assembly (e.g., the X-rail 220X). The laser carriage assembly 300, or at least portions thereof, may be detached from the rail (e.g., detached from the connecting structure 302), thus allowing a user to replace or perform maintenance on the laser carriage assembly 300. The connecting structure 302 may have a U-shape (best seen in FIG. 3E), which enables a rail cover 222 (FIG. 2C) to fit around the rail to substantially prevent inadvertent access to the drive components and other elements disposed within and/or along the rail. Said differently, the U-shape of the connecting structure 302 may extend down and around a lower lip of a rail cover 222. Power, communication, compressed air, and the like may be routed from the rail to the laser carriage assembly 300 via the connecting structure 302.

In various embodiments, the laser carriage assembly 300 also includes a lens tray 370 detachably coupled to the support structure 305. In various embodiments, and with specific reference to FIGS. 3G and 3H, the lens tray 370 defines a first optic window 373 and the lens tray 370 comprises a first optical lens 371 extending across the first optic window 373. The first optical lens may be the main optic for the laser beam emitted from the laser module 350. As such, the when the lens tray 370 is in the installed position relative to the support structure 305 (i.e., relative to the laser module 350), the laser module 350 is aligned with the lens tray 370 such that the beam axis 352 extends through the first optic window 373 and intersects the first optical lens 371. In various embodiments, keeping the first optical lens 371 clean (free of debris, smoke, contaminants) may be important for the lifespan of the laser module 350, may prevent damage to users and/or equipment, and may facilitate accurate, reliable, consistent, and repeatable crafting operations performed on workpieces. Accordingly, by having the lens tray 370 be removably coupled to the support structure 305 of the laser carriage assembly 300, the user can clean the distal end of the laser module 350 and the first optical lens 371 supported by the lens tray 370, thus facilitating realization of the aforementioned benefits.

In various embodiments, the support structure 305 comprises a lower base plate 380 (FIGS. 3C, 3E, 3F, and 3G). The lower base plate 380 may define a lowermost portion of the laser carriage assembly 300. The removable lens tray 370 may be removably retained above the lower base plate 380. That is, in the installed position the lens tray 370 may be positioned between the laser module 350 and the lower base plate 380. According to various embodiments, the lens tray 370 includes a top portion 376 and a flange portion 377. The top portion 376 is the section of the lens tray 370 that defines the first optic window 373, and the flange portion 377 extends downward from at least a portion of a periphery of the top portion 376, according to various embodiments. For example, the flange portion 377 may extend from front and side portions of the periphery of the top portion 376. Thus, rear side of the lens tray 370 may not have a flange portion extending therefrom, and thus the rear side may be inserted into a gap defined between the laser module 350 and the lower base plate 380. The flange portion 377 extending from the at least a segment of the side and front sections of the periphery of the top portion 376 are configured to engage and at least partially surround corresponding perimeter surfaces of the lower base plate 380, according to various embodiments.

To facilitate proper insertion of the lens tray 370 relative to the support structure 305, and/or to facilitate a secure yet detachable connection between the lens tray 370 and the support structure 305 and/or lower base plate 380, the laser carriage assembly 300 may include corresponding engagement features 379 between the lens tray 370 and the lower base plate 380. Said differently, interior surfaces of the flange portion 377 of the lens tray 370 may have one or more engagement features that are configured to reversibly engage with corresponding engagement features 379 (FIG. 3F) on the exterior perimeter surfaces of the lower base plate 380. The corresponding engagement features may include a groove and detent configuration or may otherwise include features configured to facilitate a secure resistance and/or interference fit between the lens tray 370 and the support structure 350/lower base plate 380.

Because of the removable configuration of the lens tray 370, the laser carriage assembly 300 may include one or more sealing members to substantially isolate the optical path from the working region 211 of the laser crafting apparatus 20, thereby inhibiting dust, smoke, or other contaminates from entering the main optical path of the laser module above the first optical lens 371. Accordingly, an O-ring or other annular sealing member may be disposed around the beam axis 352 in sealing engagement between a lower end of the laser module 350 and an upper surface of the lens tray 370 that circumscribes the first optic window 373 when the lens tray 370 is in the installed position. In various embodiments, the first optical lens 371 is coupled to a frame that is disposed within the first optic window 373, and thus the first optical lens 371 may be substantially below a top surface of the lens tray 370. In various embodiments, the lase carriage assembly 300 may include one or more hardware interlock features configured to prevent operation of the laser module 350 (and/or the laser crafting apparatus 20) in response to the lens tray 270 being detached (i.e., in response to the lens tray not being in the installed position).

The laser carriage assembly 300 may include a casing 310 configured to surround and protect the laser module 350. In various embodiments, the casing 310 extends from an upper end down to a lower end adjacent the lens tray 370. That is, the front side of the casing 310 may be substantially flush with the front side of the lens tray 370, such that the casing 310 and the flange portion 377 of the lens tray 370 are substantially continuous when the lens tray is in the installed position.

In various embodiments, and with specific reference to FIG. 3C, the laser carriage assembly 300 also includes a fan 330 and a heat sink 340. Both the fan 330 and the heat sink 340 may be coupled to the support structure 305. The heat sink 340 may be generally disposed around the laser module 350, and the fan 330 may be configured to blow cooling air across the heat sink 340 to dissipate heat from the laser module 350. In various embodiments, the fan 330 is disposed above the heat sink 340 and is coupled directly to the heat sink 340 to deliver the cooling air into and through the heat sink 340. In various embodiments, the casing 310 of the laser carriage assembly 300 surrounds the heat sink 340 and lateral side surfaces of the fan 330.

In various embodiments, the laser carriage assembly 300 further includes a detachable fan cover 320 (FIG. 3B) that forms a top surface of the casing 310 of the laser carriage assembly 300. The fan cover 320 may not be a solid/continuous panel, but instead may define slots and/or pass-through apertures to allow air to be drawn into the fan 330 and to be directed down and around the laser module 350. The detachable fan cover 320 may extend across the fan intake to prevent large debris and/or misplaced material from entering the fan 330. In various embodiments, the fan cover 320 is detachably secured to the fan 330, the casing 310, and/or the support structure 305 via magnets. The laser carriage assembly 300 may include a sensor or one or more hardware interlocks configured to detect whether the fan cover 320 is properly installed. In response to the fan cover 320 not being properly installed/seated, the laser module 350 may be deactivated.

In various embodiments, the lens tray 370 defines one or more cooling air windows 375 configured to allow the cooling air exiting the heat sink 340 to flow through the lens tray 370 and out through the lower base plate 380. In various embodiments, the one or more cooling air windows may be disposed around the first optic window 373, thereby positioned to convey the cooling air from heat sink 340 that is disposed concentrically around the laser module 350 through the lens tray 370 to the lower base plate 380. The lower base plate 380 may comprise corresponding windows and/or openings that are generally aligned with the cooling air windows 375 of the lens tray 370.

The lower base plate 380 may include one or more louvres 386 (FIGS. 3E and 3F) positioned below the one or more cooling air windows 375 of the lens tray 370. The one or more louvres 386 may be configured to direct the cooling air away from parallel with the beam axis 352. By directing the cooling air away from the beam axis 352, a desired macro ventilation flow dynamic across and through a workspace region 211 of a laser crafting apparatus 20 may be maintained. For example, in various embodiments, the laser crafting apparatus 20 is equipped with a ventilation system, as described in greater detail below with reference to FIGS. 6A-6I, that draws air horizontally across and through the workspace region 211 (e.g., across, over, and around any workpieces supported upon the material support tray 700). If the cooling air were allowed to flow down toward the workpiece (i.e., in a direction parallel to the beam axis 352 of the laser module 350), the cooling air may disrupt the desired flow dynamic properties (i.e., may disrupt a laminar flow of the main ventilation airflow) of the main ventilation air, which would potentially decrease the effectiveness of the ventilation airflow in clearing out smoke and other debris formed by the alteration of the workspace by the laser radiation from laser module 350. Thus, by having the louvres 386 redirect the air away from the direction of the beam axis 352, disruption to the main ventilation caused by the cooling airflow is mitigated/minimized.

In various embodiments, the one or more louvres 386 are configured to direct the cooling air in a direction that is between about 45 degrees and about 90 degrees from the beam axis 352. In various embodiments, the one or more louvres 386 have a concave upper surface. To facilitate redirection of the cooling air. In various embodiments, the one or more louvres 386 are configured to direct the cooling air rearward. As described in greater detail below, the ventilation system may be configured to direct the main ventilation air rearward, and thus combining the cooling air with the main ventilation air flowing in the same direction further minimizes flow disruptions to the main ventilation air.

In various embodiments, the laser carriage assembly 300 further includes a visible light module 355 coupled to the support structure 305. The visible light module 355 may be disposed adjacent the laser module 350 and may be configured to emit visible light parallel to the beam axis 352 toward the workpiece. The visible light from the visible light module 355 may enable the user to see approximately where the laser light, which may comprise non-visible electromagnetic radiation, will hit the workpiece.

In various embodiments, the laser carriage assembly 300 further includes an optical sensor 360 coupled to the support structure 305. The optical sensor 360, which may be an optical proximity transducer, may be configured to emit radiation along a sensor axis and receive reflected radiation from an upper surface of the workpiece to determine a distance between the laser module 350 and the upper surface of the workpiece. That is, the optical sensor 360 may be utilized by the controller of the laser crafting apparatus 20 as feedback to determine if the focal point of the laser will be properly located relative to the workpiece, and the laser crafting apparatus 20 can raise or lower the workpiece accordingly. The optical sensor 360 may be referred to herein as a time-of-flight sensor and may be generally disposed at or near the laser module 350. In various embodiments, the optical sensor may be utilized to inform an auto focusing of laser to accommodate larger and smaller workpieces where the top surface of the workpiece may be closer or further from the laser module 350.

In various embodiments, lens tray 370 defines a second optic window 374 and the lens tray 370 includes a second optical lens 372 extending across the second optic window 374. The second optical lens 372 may be specifically configured to facilitate accurate sensor readings, and thus the optical sensor 360 may be aligned with the lens tray 370 such that the sensor axis extends through the second optic window 374 and intersects the second optical lens 372. The second optical lens 372 may prevent debris, dust, smoke, and/or other substances from contaminating the optical sensor 360. The second optical lens 372 may also comprise an anti-reflectance coating that is configured to reduce some of the signal noise that would otherwise be received by the optical sensor, thus improving the signal to noise ratio of the optical sensor 360.

In various embodiments, and with specific reference to FIG. 3E, the lower base plate 380 further includes a nozzle configured to provide air assist at the focal point of the lasering where the material alterations are occurring. That is, the lower base plate 380 may include a nozzle 382 extending downward and away from the laser module 350. The nozzle 382 may be configured to direct compressed air, from a compressor of the laser crafting apparatus 20, toward the workpiece. In various embodiments, the nozzle 382 is aligned with the laser module 350 such that the beam axis 352 extends through the nozzle 382. In various embodiments, the lower base plate 380 defines a compressed air channel 385 configured to deliver the compressed air from a compressed air source to the nozzle 382.

The laser carriage assembly 300 may also include a ring gasket 383 disposed around the beam axis 352 in sealing engagement between the nozzle 382 of the lower base plate 380 and a lower surface of the lens tray 370 that circumscribes the first optic window 373 when the lens tray 370 is in the installed position. That is, a ring gasket 383 may promote a sealing engagement between the removable lens tray 370 and the lower base plate 380, thereby preventing or at least inhibiting unwanted dust, debris, smoke, and other substances from contaminating the main optical path of the radiation emitted from the laser module 350.

In various embodiments, the ring gasket 383 also defines a passage 384 that fluidly connects the compressed air channel 385 to the nozzle 382 such that the compressed air is routed through the ring gasket 383 to the nozzle 382. In such configurations, the ring gasket 383 not only prevents contaminants from entering the main optical path but may also seal against unwanted compressed air leaks as the compressed air is delivered to the nozzle to be directed at the burn point of the laser.

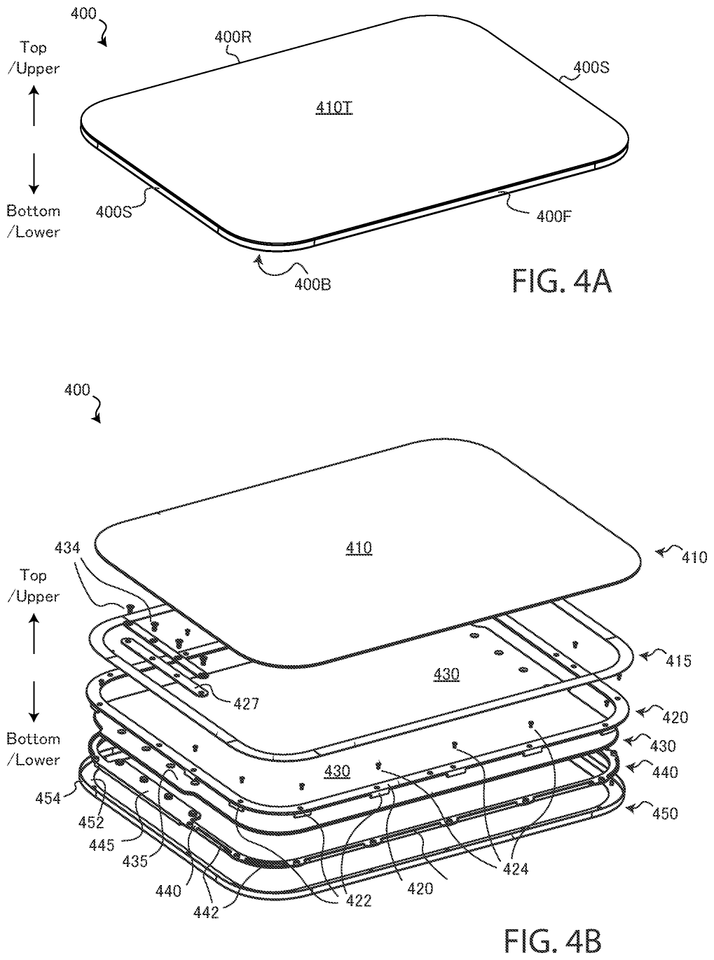

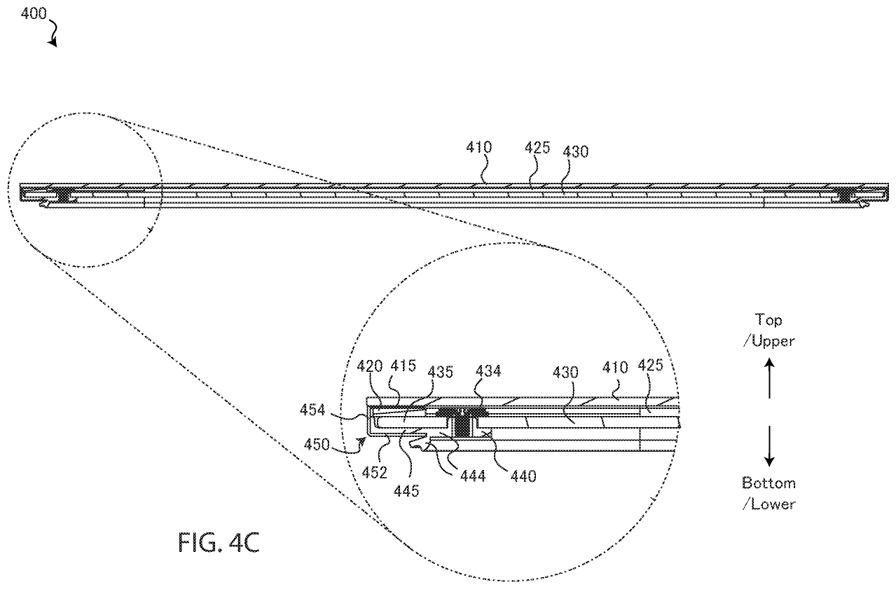

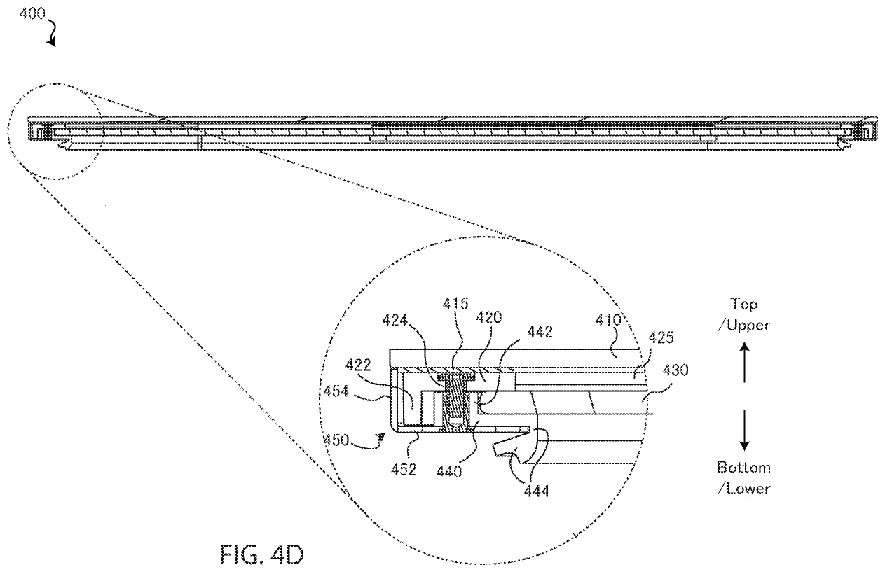

In various embodiments, and with reference to FIGS. 4A, 4B, 4C, and 4D, details of the lid 400 for the laser crafting apparatus 20 are provided. The lid 400 generally has a dual layered structure configured to mitigate harmful electromagnetic radiation and to mitigate the spread of fire in the event of a flame-up induced by the lasering. Therefore, the lid 400 may have a radiation attenuation layer 410 and a fire suppression layer 430, in accordance with various embodiments. Even with the dual layers, the lid 400 may still be configured to be sufficiently transparent for visible light such that the user can see the laser process/operation occurring. The lid 400 may only have sufficient structural strength to be repeatedly manipulated by a user but can also safely attenuate inadvertent transmission of harmful electromagnetic energy therethrough while also providing a degree of fire containment.

In various embodiments, and with specific reference to FIG. 4A, the lid 400 may have a perimeter that comprises a front edge 400F, a rear edge 400R opposite the front edge 400F, and opposing lateral side edges 400S. In various embodiments, the radiation attenuation layer 410 and the fire suppression layer 430 may be parallel to each other, and both the radiation attenuation layer 410 and the fire suppression layer 430 may extend continuously within the perimeter such that a majority of a body mass of the lid 400 is comprised of the radiation attenuation layer 410 and the fire suppression layer 430. Said differently, the radiation attenuation layer 410 and the fire suppression layer 430 may be the only components of the lid 400 that extend across the entire body of the lid 400, as the other layers and components mentioned below may only be frame members that partially surround and/or engage one or both peripheries of the radiation attenuation layer 410 and the fire suppression layer 430.

In various embodiments, the radiation attenuation layer 410 forms a top exterior surface of the lid4 400. In various embodiments, the fire suppression layer 430 forms a bottom interior surface of the lid 400 (i.e., the portion of the lid 400 that is configured to face the internal volume 209 of the laser crafting apparatus 20). The radiation attenuation layer 410 may comprise at least one of a thermoplastic material and synthetic polymer. For example, the radiation attenuation layer 410 may comprise poly(methyl methacrylate). The radiation attenuation layer 410, according to various embodiments, is colored to attenuate transmission of electromagnetic radiation from the laser module 350 of the laser carriage assembly 300. For example, the radiation attenuation layer 410 may be colored green or orange, depending on the specific wavelength of electromagnetic radiation configured to be generated/emitted by the laser module 350. In various embodiments, the fire suppression layer 430 may comprise a glass material. For example, the fire suppression layer 430 may be borosilicate glass.

In various embodiments, the two layers 410, 430 of the lid 400 are separated from direct contact with each other by an intermediate spacer frame 420. Said differently, an intermediate spacer frame 420 may be disposed between the radiation attenuation layer 410 and the fire suppression layer 430. The intermediate spacer frame 420 may only contact respective peripheries of the two main layers 410, 430, and thus a gap 425 (e.g., an air gap) may be defined between the radiation attenuation layer 410 and the fire suppression layer 430.

In various embodiments, the radiation attenuation layer 410 is bonded and/or adhered to an upper surface of the intermediate spacer frame 420. That is, an adhesive perimeter layer 415 may bond the radiation attenuation layer 410 to the intermediate spacer frame 420. In various embodiments, the lid 400 further includes a base frame 450. The intermediate spacer frame 420 may be coupled to the base frame 450 via a plurality of fasteners 424 such that the fire suppression layer 430 is retained/compressed between a lower surface of the intermediate spacer frame 420 and an upper surface of the base frame 450. More specifically, and according to various embodiments, the base frame 450 includes a bottom portion 452 and a sidewall portion 454, and the plurality of fasteners 424 may connect the intermediate spacer frame 420 to the bottom portion 452 of the base frame 450 in order to compress and retain the fire suppression layer 430 therebetween.

FIG. 4D is a cross-sectional view of the lid 400, taken along a section that intersects one of the plurality of fasteners 424, according to various embodiments. In various embodiments, a majority of the plurality of fasteners 424 are positioned outward of a periphery of the fire suppression layer 430. That is, more than half of the plurality of fasteners 424 do not extend through the fire suppression layer 430, but instead extend adjacent to the periphery of the fire suppression layer 430. In various embodiments, each one (i.e., all) of the fasteners that are used to affix the intermediate spacer frame 420 to the base frame 450 do not extend through the fire suppression layer 430. The structural strength and structural toughness of the fire suppression layer 430 is augmented by having fewer fastener holes extending therethrough, in accordance with various embodiments.

With reference to FIGS. 4B and 4D, the intermediate spacer frame 420 may have a plurality of tabs 422 that that extend downward around the periphery of the fire suppression layer 460 and engage the upper surface of bottom portion 452 of the base frame 450. In various embodiments, these tabs 422 are only respectively disposed in a vicinity of the plurality of fasteners 424. In such a configuration, the plurality of tabs 422 prevent uneven cantilevering of the intermediate spacer frame 420 in response to securement of the plurality of fasteners 424 during manufacturing of the lid 400. That is, were it not for the tabs 422, the compression of the fasteners 424 would cause the localized section of the intermediate spacer frame to deform in the vicinity of the fasteners 424, due to the fact that on an inner side of the fasteners the intermediate spacer frame would be supported by the fire suppression layer whereas on the outer side of the fasteners there would be nothing to support against the compression, and thus the intermediate spacer frame may deform, thereby diminishing the strength of the compression on the fire suppression layer.

In various embodiments, the sidewall portion 454 of the base frame 450 at least partially surrounds a periphery of the intermediate spacer frame 420. In various embodiments, an upper rim of the sidewall portion 454 of the base frame 450 faces a lower surface of the radiation attenuation layer 410. In various embodiments, the lid 400 includes a gasket frame 440 disposed between a lower surface of the fire suppression layer 430 and the upper surface of the bottom portion 452 of the base frame 450. The gasket frame 440 may comprise a resiliently flexible material configured to absorb some of the forces of the lid 400. Thus, instead of the fire suppression layer 430 being compressed (by the fasteners 424) into direct contact with the rigid (e.g., metallic) base frame 450, the gasket frame 440 may provide an intervening cushion and/or force dissipation layer between the fire suppression layer 430 and the base frame 450, in accordance with various embodiments.

In various embodiments, and with specific reference to FIGS. 4B and 4D, the gasket frame 440 includes one or more ribs 442 that extend upward from a periphery of the gasket frame 440 and at least partially surround a periphery of the fire suppression layer 430. The ribs 442 may provide at least a partial outline that surrounds the periphery of the fire suppression layer 430, thus facilitating proper seating and position of the fire suppression layer 430 in the stackup of layers. In various embodiments, the one or more ribs 442 may be disposed between the fire suppression layer 430 and the plurality of fasteners 424 extending between the intermediate spacer frame 420 and the bottom portion 452 of the base frame 450. Additionally, or alternatively, the plurality of fasteners 424 may extend through the gasket frame 440, but the gasket frame 440 may have a grommet, boss, or other raised feature surrounding the fasteners 424, thus the ribs 442 and/or these grommets/bosses of the gasket frame 440 provide a force absorption/cushioning benefit by preventing the periphery of the fire suppression layer 430 from directly contacting the fasteners 424, according to various embodiments.

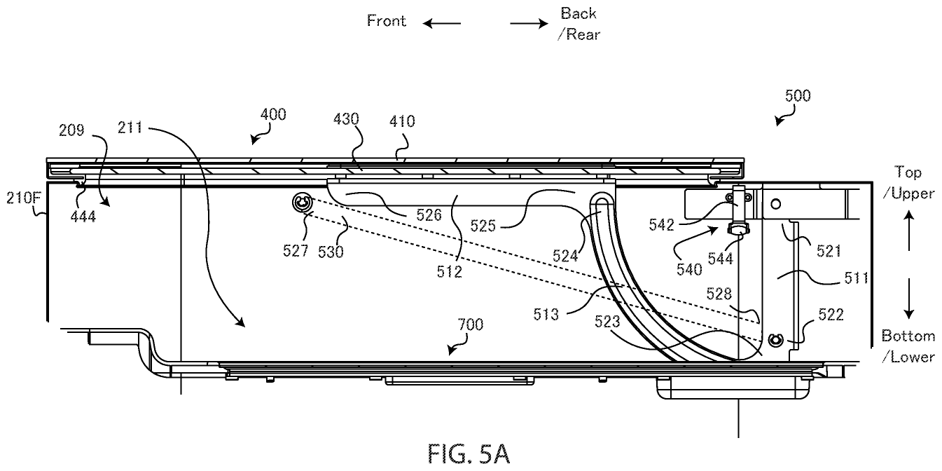

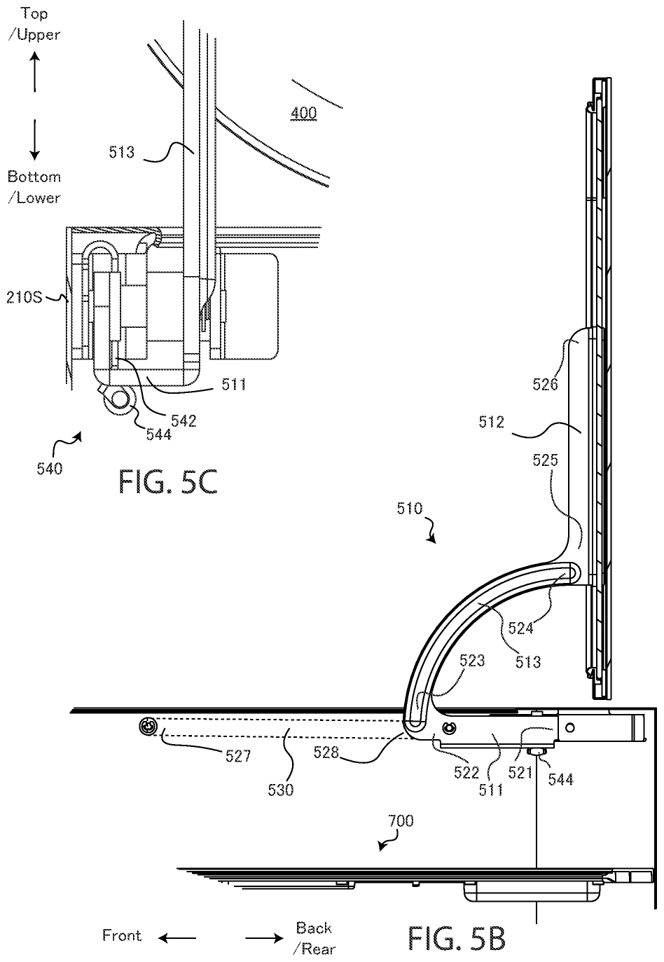

In various embodiments, the gasket frame 440 comprises a wrap-around lip 444 that extends within an inner rim of the bottom portion 452 of the base frame 450 and extends back outward below the bottom portion 452 of the base frame 450. That is, as shown in FIG. 4D, the gasket frame 440, or at least the wrap-around lip 444 of the gasket frame 440, is made from a resiliently flexible material that is configured to deform into engagement with an upper surface of the housing 210 of the laser crafting apparatus 20 in response to the lid 400 being closed against the housing 210. Said differently, the wrap-around lip 444 of the gasket frame 440 may be specifically configured to engage an upper or an inner surface (or both) of a top edge of the housing 210 of the laser crafting apparatus (see FIG. 5A). This engagement of the gasket frame 440 against the housing 210 of the laser crafting apparatus 20 may provide optical sealing between the lid 400 and the housing 210, thereby preventing or at least inhibiting inadvertent leakage of electromagnetic radiation from the internal volume 209 of the laser crafting apparatus 20.

In various embodiments, the fire suppression layer 430 comprises outwardly extending wing portions 435 to which pivoting arms 510 of a hinge structure of the laser crafting apparatus 20 are respectively coupled. That is, one or more hinge fasteners 434 (FIGS. 4B and 4C) may be anchored on one end to a bracket 427 that is disposed in the gap 425 between the radiation attenuation layer 410 while the opposing end of the hinge fasteners 434 are anchored to a portion of a pivoting arm 510 of the hinge structure 500 of the laser crafting apparatus 20. The hinge fasteners 434 are different and separate from fasteners 424 mentioned above in that the hinge fasteners 434 extend through holes defined in the fire suppression layer 430, the hinge fasteners 434 are inward of fasteners 424, and the hinge fasteners 434 are not anchored to the base frame 450 like fasteners 424. In various embodiments, in order to absorb forces between the bracket 427 and the fire suppression layer, a cushion segment is disposed between the bracket 427 and the upper surface of the fire suppression layer 430. In various embodiments, the gasket frame 440 comprises a wing portion 445 that corresponds and vertically aligns with the wing portion 435 of the fire suppression layer 430. The wing portion 445 of the gasket frame 440 may be configured to provide similar cushioning/force absorption between the lower surface of the fire suppression layer 430 and the pivoting arm 510 of the hinge structure 500. In various embodiments, the wing portion 445 of the gasket frame 440 extends inward from the periphery of the gasket frame 440 (whereas the wing portion 435 of the fire suppression layer 430 extends outward from the periphery of the fire suppression layer 430).

In various embodiments, force transfer between the lid 400 and the one or more pivoting arms 510 of the hinge structure 500 of the laser crafting apparatus 20 is exclusively via the fire suppression layer 430. That is, instead of the pivoting arms 510 being coupled to a rigid perimeter/frame layer, the pivoting arms 510 are directly coupled to the fire suppression layer 430. This ‘direct’ coupling does not necessarily mean direct physical contact, as one or more cushioning/force absorption layers may be disposed between the fire suppression layer and the pivoting arms 510, but rather this ‘direct’ coupling refers to the nature of the engagement between the two components, as there are no other intervening rigid structures in the force transfer communication between the fire suppression layer 430 and the pivoting arms 510.

In various embodiments, and with reference to FIGS. 5A, 5B, and 5C, details pertaining to the hinge structure 500 are provided. The lid 400 is generally configured to be pivotably coupled to the housing 210 of the laser crafting apparatus 20 via a hinge structure 500. The hinge structure 500, according to various embodiments, comprises one or more pivoting arms 510 that extends from a hinge/pivot point to the lid 400. For example, each pivoting arm 510 may include a first portion 511 pivotably coupled to the housing 210 and a second portion 512 coupled to the lid 400. As mentioned above, the connection between the second portion 512 of the pivoting arm 510 and the lid 400 may be at the fire suppression layer 430 of the lid 400 (such that force transfer between the pivoting arm 510 and the lid 400 is exclusively via the fire suppression layer 430). The first portion 511 and the second portion 512 of the pivoting arm 510 may generally extend in non-parallel directions.

In various embodiments, the hinge structure 500 includes a damping device coupled to the pivoting arm 510. The damping device may be configured to slow rotation of the lid 400 as it rotates from the open position to the closed position. In various embodiments, the damping device provides no rotation damping as the lid 400 rotates from the closed position to the open position, thus allowing the user to easily lift the lid 400 to the open position without having to fight against the effects of the damping device.

In various embodiments, the damping device is an extension damper 530 (shown schematically in FIGS. 5A and 5B). The extension damper 530 may have a linear telescoping structure that is specifically configured to damp extension of its structure while allowing free contraction of its structure. In various embodiments, the extension damper 530 is a two-stage damper and is thus configured to slow rotation of the lid 400 toward the closed position even when the lid has only been opened a few degrees. Said differently, the extension damper 530 may be configured to provide extension damping substantially along its entire range of linear motion.

In various embodiments, the first portion 511 of the pivoting arm 510 is perpendicular to the second portion 512. In various embodiments, the pivoting arm 510 also includes a curved portion 513 extending between the first portion 511 and the second portion 512. In various embodiments, and with continued reference to FIGS. 5A-5C, the first portion 511 of the pivoting arm 510 comprises a first end 521 pivotably coupled to the housing 210 and a second end 522, opposite the first end 521, coupled to a third end 523 of the curved portion 513. The curved portion 513 may comprise a fourth end 524 coupled to a fifth end 525 of the second portion 512, and the second portion 5112 may comprise a sixth end 526 opposite the fifth end 525. In various embodiments, the fifth end 525 of the second portion 512 is closer to the first end 521 of the first portion 511 than the second end 522 of the first portion 511. In various embodiments, the extension damper 530 comprises a seventh end 527 pivotably coupled to the housing 210 of the laser crafting apparatus 20 (forward of the main hinge axis of the hinge structure) and an eighth end 528 that is pivotably coupled to at least one of the second end 522 of the first portion 511 of the pivoting arm 510 and the third end 523 of the curved portion 513 of the pivoting arm 510. Such a configuration may be especially well-suited for extension-type dampers (e.g., damper 530), as the range of motion experienced by the pivoting arms 510 results in well-balanced and smooth closing motion throughout the damped extension dynamic. The configuration of the hinge structure in such configurations may provide compact assembly that allows the user easy access to the internal volume without cumbersome a cumbersome and/or bulky hinge structure occupying substantial space, or blocking or at least limiting the user's access to the internal volume from the sides of the machine.

In various embodiments, the hinge structure 500 further includes a lid retainer mechanism 540 that is configured to hold the lid 400 in the open position to prevent inadvertent, premature, and/or accidental closure of the lid 400. In various embodiments, the hinge structure 500 is configured to enable the lid 400 to rotate just beyond 90 degrees. While this degree of rotation may provide some resistance to the lid 400 inadvertently or accidentally closing, the lid retainer mechanism 540 may provide additional security to prevent inadvertent closure of the lid 400. In various embodiments, the lid retainer mechanism 540 comprises an arm 542 and an engagement feature 544. The arm 542 may be a spring arm or may otherwise be configured to bias the engagement feature 544 into engagement with one or more of the pivoting arms 510 of the hinge structure 500.

In response to the lid 400 being sufficiently opened, the lid retainer mechanism 540 may be configured to ‘lock’ the hinge structure 500 from reversing the rotation (i.e., inhibiting rotation back toward the closed position). For example, the engagement feature 544 may be configured to ride/slide along one of the portions of the pivoting arms 510, such as the first portion 511, until the lid 400 has been sufficiently opened, at which point the engagement feature 544 passed below a surface of the pivoting arm segments to inhibit reverse rotation unless the reversal force is sufficient (indicating intention by the user to close the lid 400). In response to this deliberate, sufficient force, the bias of the arm 542 of the lid retainer mechanism is overcome, thus disengaging the engagement feature from the respective section of the pivoting arm to thus allow the lid 400 to return to the closed position.

In various embodiments, and with reference to FIGS. 6A-6H, details of a ventilation system for a laser crafting apparatus 20 are provided. As mentioned above, the laser crafting apparatus 20 may be configured to generate flow of ventilation air across and through at least the workspace region 211 of the internal volume 209 to facilitate removal of debris, dust, smoke, liberated particles of workpiece, and/or other contaminants from the working space. With proper ventilation, contaminant build-up is limited and thus user are enabled to operate longer between maintenance/cleaning. Indeed, if debris particles are not removed sufficiently from inside the laser crafting apparatus 20 during and/or after operation of the laser, contaminants can build up on, and damage, components of the apparatus over time. For example, laser lenses may get clouded over time, gears, motors, and drive belts may become gummed up, and other crucial components may deteriorate over time if these byproduct particles in the air are not sufficiently removed or cleaned.

The laser crafting apparatus 20 may define a ventilation pathway through which ventilation air is configured to flow during operation of the laser crafting apparatus. The ventilation pathway may comprise the workspace region of the internal volume of the laser crafting apparatus. The laser crafting apparatus 20 may be specifically configured to control and/or optimize the fluid dynamics of the ventilation air in the ventilation pathway to maximize removal of contaminants and/or to promote the safe performance of laser work on a workpiece. Further benefits from proper ventilation are fire suppression and heat removal. In various embodiments, the laser crafting apparatus comprises an extractor fan 650 configured to pull the ventilation air through the ventilation pathway and ultimately force the ventilation air out of the internal volume 209 of the laser crafting apparatus 20. That is, the ventilation system of the laser crafting apparatus 20 may not push air through the ventilation pathway with a forced air mechanism, but instead may draw air across the working region 211 using an extractor fan 650 with its intake coupled in fluid receiving communication with the internal volume 209. By having air pulled across the workpiece and pulled through the workspace region 211, the workspace region 211 in negative pressure, which means the machine does not need to be fully sealed to contain the effluent. If a fan we included to force the air from the intake into the working volume of the machine, any leaks in the machine housing would cause the effluent to leak out of the machine housing.

In various embodiments, the laser crafting apparatus includes a pre-filter 620 disposed in the ventilation pathway between the workspace region 211 of the internal volume 209 of the laser crafting apparatus 22 and the extractor fan 650. The extractor fan 650 may be disposed at a rear of the housing 210, and thus the ventilation air may be configured to flow from the front toward the rear of the machine. In various embodiments, it may be advantageous to position the extractor fan 650 near the back of machine for improved acoustics, form factor, and the utilization of available space. The pre-filter 620 may be configured to remove some contaminants and debris before such particles reach the extractor fan 650 itself. Such a pre-filter 620 may be on-board the machine and as such the pre-filter 620 may face and at least partially define the working region 211 of the laser crafting apparatus 20. Said differently, the pre-filter 620 may form at least a segment of a rear wall of the working region 211.

In various embodiments, and with specific reference to FIG. 6C, the pre-filter 620 comprises a filter frame 622 retaining a filter media 624. The filter frame 622 may be detachably coupled to the housing 210 of the laser crafting apparatus 20, thus allowing the pre-filter to be detached and removed so a user may clean or replace the filter media 624. In various embodiments, laser crafting apparatus 20 further includes a baffle plate 630 disposed in the ventilation pathway between the pre-filter 620 and the extractor fan 650. The baffle plate 630 may be disposed adjacent but rearward of the pre-filter 620 and may be configured to promote the ventilation air being distributed across the pre-filter 620. Rearward of the baffle plate 630 is a tunnel 640 in the ventilation pathway between the pre-filter 620 and the extractor fan 650, according to various embodiments. The tunnel 640 has a converging cross-section, relative to a flow direction of the ventilation air, from the pre-filter 620 toward the extractor fan 650, according to various embodiments.

In various embodiments, the housing 210 of the laser crafting apparatus at least partially defines an intake pathway. The intake pathway, which may be a portion of the overall ventilation pathway, may generally be defined in the housing 210 forward of the workspace region 211. For example, the intake pathway may be defined, at least partially, but a front panel 210F of the housing 210 of the laser crafting apparatus 20. The intake pathway, as described below, is configured to redirect the ventilation air from one or more intake ports 612 defined by a bottom panel 210B of the housing 210 of the laser crafting apparatus 20 to one or more delivery ports 618 facing the workspace region 211 of the internal volume 2109 of the laser crafting apparatus 20. The

In various embodiments, the intake pathway comprises an L-shaped intake channel 614 at least partially defined by the front panel 210F of the laser crafting apparatus. The L-shaped intake channel 614 of the intake pathway may include a vertical plenum 616 and an upper horizontal plenum 617. The L-shaped intake channel 614 of the intake pathway may be disposed forward of the workspace region 211. In various embodiments, the upper horizontal plenum 617 fluidly connects the vertical plenum 616 to the one or more delivery ports 618. The upper horizontal plenum 617 may be configured to horizontally straighten the ventilation air before the ventilation air passes through the one or more delivery ports 618 to the workspace region 211 of the internal volume 209 of the laser crafting apparatus 20. The L-shaped intake channel may also include a lower horizontal plenum 615 that fluidly connects the one or more intake ports 612 to the vertical plenum 616.

In various embodiments, the ventilation air in the lower horizontal plenum 615 flows generally toward a front surface of the laser crafting apparatus and the ventilation air in the upper horizontal plenum 617 flows generally toward a rear surface of the laser crafting apparatus 20. In various embodiments, the one or more delivery ports 618 are configured to deliver laminar air to the workspace region 211 of the internal volume 209 of the laser crafting apparatus 20. The one or more delivery ports 618 are configured such that ventilation air exiting the one or more delivery ports 618 forms a curtain of air, wherein the curtain of air has a width that is greater than a width of the material support tray 700 disposed within the workspace region 211 of the internal volume 209 of the laser crafting apparatus 20. In various embodiments, the upper horizontal plenum 617 and/or the delivery ports 618 are configured such that the emitted curtain of air always ‘covers’ the focal point of the laser.

The laser crafting apparatus 20 may also include a hose module 660 detachably coupled to the housing 210 of the laser crafting apparatus 20. For example, the hose module 660 may be coupled to a rear panel 210R of the housing 210 of the laser crafting apparatus 20. The extractor fan 650 may be component of the hose module 660. There may be one or more hardware interlock features configured to prevent operation of the laser crafting apparatus in response to the hose module being detached from the housing of the laser crafting apparatus.

In various embodiments, the hose module 660 is connectable to the housing 210 of the laser crafting apparatus 20 in two different orientations, such that an outlet (i.e., a hose 668) of the hose module 660 can be switched to face in either a left or a right direction relative to the housing 210 of the laser crafting apparatus 20. Accordingly, the hose module may be configured to redirect incoming ventilation air about 90 degrees to exit the hose module via the outlet. In various embodiments, the hose 668 of the hose module 660 may be coupled to a hose port 678 of a window unit 670 (FIG. 6I) for exhausting the effluent outside. Alternatively, the hose 668 may be coupled to a standalone filter unit.

In various embodiments, the extractor fan 650 is a centrifugal fan. The hose module 660 of the laser crafting apparatus 20 may comprise two electrical connectors 662A, 662B, wherein each electrical connector of the two electrical connectors is separately and individually connectable to a single electrical connection port 162 extending from the housing 210 of the laser crafting apparatus 20. This configuration allows for the extractor fan 650 disposed within the hose module 660 to be powered regardless of the orientation of the hose module 660.

In various embodiments, the housing 210 of the laser crafting apparatus comprises a rear panel 210R having a rear surface that defines a socket 218. The hose module 660 may be detachably coupled to the housing 210 at the socket 218. In various embodiments, the hose module 660 has an interface plate 661 configured to detachably engage the socket 218. In various embodiments, and inlet of the hose module is defined by the interface plate 661. In various embodiments, the interface plate 661 is detachable from the hose module 660 to allow user access to the extractor fan 650 housed within a fan casing 664. For example, the interface plate 661 may define at least one finger scoop 663 to facilitate separation of the interface plate 661 from the hose module 660.

The fan casing 664 of the hose module 660 may include a first portion 665 and a second portion 666, with the first portion 665 and the second portion 666 of the fan casing 664 collectively defining airflow surfaces around the extractor fan 650. The first portion 665 of the fan casing 664 may be mounted to the interface plate 661 and may be separable from the second portion 666 of the fan casing 664 to allow user wide access to the extractor fan 650 for cleaning and/or replacement of the extractor fan 650.

In various embodiments, the laser crafting apparatus 20 includes one or more sensors (e.g., safety sensors) configured to detect conditions within the apparatus. The laser crafting apparatus 20 may include at least one atmospheric sensor configured to detect a composition of air that is within and/or flowing out of the internal volume 209 of the laser crafting apparatus 20. For example, the laser crafting apparatus 20 may include one or more volatile organic compounds (“VOC”) sensors for detecting emissions of the apparatus during operation. The VOC sensor may be used downstream from the pre-filter 620 to make sure that air exiting the machine is adequately clean. The VOC sensor may compare the exiting air with the ambient air as a baseline reference to determine adequacy of the ventilation/filtration system. In various embodiments, one or more of these types of sensors may be placed upstream and downstream from the pre-filter to determine the efficacy of the filter and to determine when the pre-filter 620 should be cleaned and/or the filter media replaced.

In various embodiments, the laser crafting apparatus 20 includes at least one temperature sensor configured to detect a temperature of at least one of the laser module 350 and air (e.g., ventilation air) within the internal volume 209 of the laser crafting apparatus 20. The laser crafting apparatus 20 may include one or more temperature sensors at or near the top of the internal volume 209 of the apparatus. The temperature sensor may be a thermistor or a thermocouple and could be used to detect a rapid rise in temperature, either from a sustained, unwanted fire or from a lack of ventilation due to a malfunctioning of the ventilation system.

The laser crafting apparatus may include a flame sensor configured to detect a presence of flames within the internal volume 209 of the laser crafting apparatus 20. The flame sensor may determine if a sustained fire is or has occurred within the apparatus. The flame sensor may be an infrared sensor configured to identify flames. While small, periodic flames may flair up during normal cutting or engraving, the flame sensor may be configured to detect the presence of a sustained, larger fire. If, for example, a small flame is detected, and the position of the small flame corresponds to the cut spot of the laser, then a threshold may not be exceeded. If, on the other hand, a larger flame that lasted a certain amount of time and was present elsewhere from the cut spot, this could exceed the threshold and trigger a shutdown of machine or other fire extinguishing protocols.

In various embodiments, the laser crafting apparatus includes an accelerometer coupled to the laser carriage assembly 300 configured to detect movement (or lack thereof) of the laser carriage assembly 300. If instructions are still being sent for the laser carriage assembly 300 to move, but the accelerometer detects no movement, this indicates a malfunctioning of some drive component of the carriage. Such a determination may trigger an auto shutoff or other mitigating protocol because a non-moving laser emitting light at the same spot of a working material for an extended period of time may lead to unwanted fires or a poor/unwanted alteration of the working material. In various embodiments, the laser crafting apparatus may include a glass-break sensor configured to detect breakage of the lid.

In various embodiments, the laser crafting apparatus includes one or more hardware interlock features configured to prevent or at least limit operation of the laser crafting apparatus 20. For example, in response to the lid 400 not being closed (i.e., in response to the laser crafting apparatus being in an open configuration), one or more hardware interlocks may be configured to shut down the laser module. Other examples of hardware interlocks and other examples sensor feedback are described above. The computing device(s) that control the laser crafting apparatus may be configured to shut-down various functionality of the apparatus in response to the sensor and/or hardware feedback. In various embodiments, however, the controller/computing device is configured to pause (not cancel) operation on the workpiece while enabling subsequent resumption of the operation on the workpiece (e.g., after an issue or detected problematic condition has been resolved). The laser crafting apparatus may also include one or more tachometers or other speed sensors configured to detect the operating fan speed of the extractor fan. The detected speed of the fan may be useful for estimating air flow rate and/or for determining when the pre-filer needs to be cleaned and/or replaced.

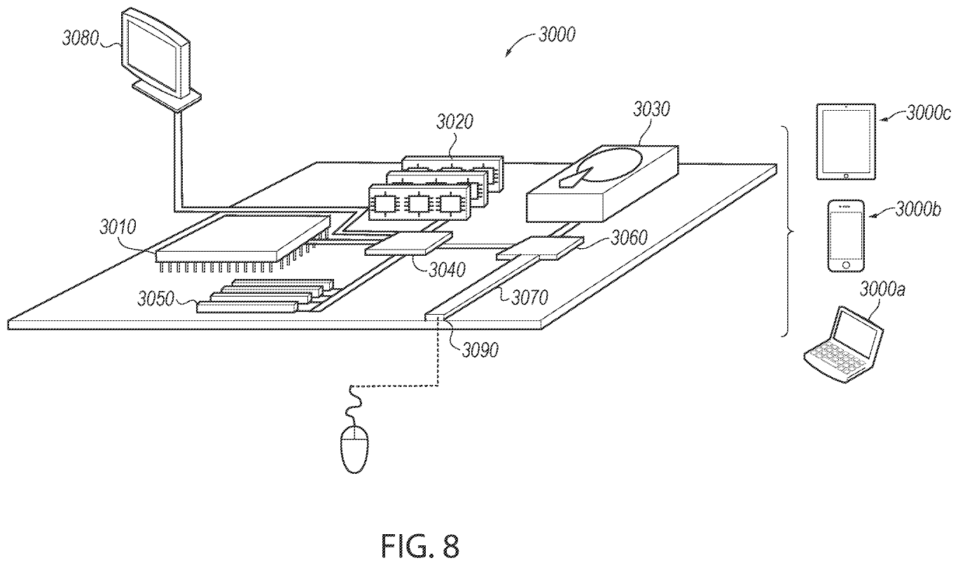

FIG. 8 is schematic view of an example computing system/device 3000 that may be used to implement the systems and methods described in this document. The computing device 3000 is intended to represent various forms of digital computers, such as laptops, desktops, smartphones, workstations, personal digital assistants, servers, blade servers, mainframes, and/or other appropriate computers. The components of the computing device 3000, such as 3010, 3020, 3030, 3040, 3050, and 3060, their connections and relationships, and their functions, are meant to be exemplary only, and are not meant to limit implementations of the inventions described and/or claimed in this document. Further, the various features and functionality of the computing device 3000 may be implemented in one or more standalone computer and/or one or more controllers, may be integrated within the disclosed laser crafting apparatus 10, 20 itself, and/or may be implemented with various other computing devices, as described below.

The computing device 3000 may include a processor 3010, memory 3020, a storage device 3030, a high-speed interface/controller 3040 connecting to the memory 3020 and high-speed expansion ports 3050, and a low-speed interface/controller 3060 connecting to a low-speed bus 3070 and a storage device 3030, according to various embodiments. Each of the components 3010, 3020, 3030, 3040, 3050, and 3060, may be interconnected using various busses, and may be mounted on a common motherboard or in other manners as appropriate.

The processor 3010 can process instructions for execution within the computing device 3000, including instructions stored in the memory 3020 or on the storage device 3030. The instructions may include operations to display graphical information for a graphical user interface (GUI) on an external input/output device, such as display 3080 coupled to high-speed interface 3040. In various implementations, multiple processors and/or multiple buses may be used, as appropriate, along with multiple memories and types of memory. Also, multiple computing devices 3000 may be connected (e.g., as a server bank, a group of blade servers, or a multi-processor system), with each device providing portions of the operation/functionality.

The memory 3020 stores information non-transitorily within the computing device 3000. The memory 3020 may comprise a computer-readable medium, a volatile memory unit(s), and/or non-volatile memory unit(s). The non-transitory memory 3020 may be physical devices used to store programs (e.g., sequences of instructions) or data (e.g., program state information) on a temporary or permanent basis for use by the computing device 3000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 3030 may be capable of providing mass storage for the computing device 3000. In some implementations, the storage device 3030 is a computer-readable medium. In various implementations, the storage device 3030 may be a floppy disk device, a hard disk device, an optical disk device, a tape device, a flash memory or other similar solid state memory device, and/or an array of devices, including devices in a storage area network or other configurations. In various implementations, a computer program product is tangibly embodied in an information carrier. The computer program product may contain instructions that, when executed, perform one or more methods, such as those described herein. The information carrier may be a computer- or machine-readable medium, such as the memory 3020, the storage device 3030, and/or memory on processor 3010.

The high-speed controller 3040 may manage bandwidth-intensive operations for the computing device 3000, while the low-speed controller 3060 may manage lower bandwidth-intensive operations. Such allocation of duties is exemplary only. In some implementations, the high-speed controller 3040 is coupled to the memory 3020, the display 3080 (e.g., through a graphics processor or accelerator), and to the high-speed expansion ports 3050, which may accept various expansion cards (not shown). In some implementations, the low-speed controller 3060 is coupled to the storage device 3030 and a low-speed expansion port 3090. The low-speed expansion port 3090, which may include various communication ports (e.g., USB, Bluetooth, Ethernet, wireless Ethernet), may be coupled to one or more input/output devices, such as a keyboard, a pointing device, a scanner, and/or a networking device such as a switch or router, e.g., through a network adapter.

The computing device 3000 may be implemented in various forms. For example, the computing device 3000 may be implemented in one or a combination of the laser crafting apparatus 10, 20, a laptop computer 3000a, a mobile device 3000b, a tablet device 3000c, and/or the following components. In various implementations of the systems, operations, functionality, and techniques described herein can be realized in digital electronic and/or optical circuitry, integrated circuitry, FPGA (field programmable gate array), specially designed ASICs (application specific integrated circuits), programmable logic device, discrete gate or transistor logic, discrete hardware components, computer hardware, firmware, software, and/or combinations thereof.

The processes, functions, operations, and/or logic flows described in this specification can be performed by one or more programmable processors, also referred to as data processing hardware, executing one or more computer programs to perform functions by operating on input data and generating output. The processor and the memory can be supplemented by, or incorporated in, special purpose logic circuitry. Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

These computer programs (also known as programs, software, software applications, and/or code) include machine instructions for a processor and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

To provide for interaction with a user, one or more aspects of the disclosure can be implemented on a computer having a display device, e.g., a CRT (cathode ray tube), LCD (liquid crystal display) monitor, or touch screen (e.g., a display of a user device) for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. No claim element is intended to invoke 35 U.S.C. 112(f) unless the element is expressly recited using the phrase “means for.”

As used herein, the terms “including,” “comprising,” “having,” and variations thereof mean “including but not limited to” unless expressly specified otherwise. Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “some embodiments,” “various embodiments,” “one example,” “an example,” “some examples,” “various examples,” “one implementation,” “an implementation,” “some implementations,” “various implementations,” “one aspect,” “an aspect,” “some aspects,” “various aspects,” etc., indicate that the embodiment, example, implementation, and/or aspect described may include a particular feature, structure, or characteristic, but every embodiment, example, implementation, and/or aspect may not necessarily include the particular feature, structure, or characteristic. Moreover, such phrases are not necessarily referring to the same embodiment, example, implementation, or aspect. Thus, when a particular feature, structure, or characteristic is described in connection with an embodiment, example, implementation, and/or aspect, it is submitted that it is within the knowledge of one skilled in the art to affect such feature, structure, or characteristic in connection with other embodiments, examples, implementations, and/or aspects, whether or not explicitly described. Absent an express correlation to indicate otherwise, features, structure, components, characteristics, and/or functionality may be associated with one or more embodiments, examples, implementations, and/or aspects of the present disclosure. After reading the description, it will be apparent to one skilled in the relevant art how to implement the disclosure in alternative configurations.

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

All ranges and ratio limits disclosed herein may be combined. Numbers, percentages, ratios, or other values stated herein are intended to include that value, and also other values that are “about” or “approximately” the stated value, as would be appreciated by one of ordinary skill in the art encompassed by embodiments of the present disclosure, unless otherwise defined herein. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Different cross-hatching may be used throughout the figures to denote different parts but not necessarily to denote the same or different materials. Surface shading lines may be used throughout the figures to denote different parts or areas but not necessarily to denote the same or different materials. In some cases, reference coordinates may be specific to each figure. Furthermore, the connecting lines shown in the various figures contained herein are intended to represent exemplary functional relationships and/or physical couplings between the various elements. It should be noted that many alternative or additional functional relationships or physical connections may be present in a practical system.

Any reference to attached, fixed, connected or the like may include permanent, removable, temporary, partial, full and/or any other possible attachment option. Additionally, any reference to without contact (or similar phrases) may also include reduced contact or minimal contact. In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, one element being “coupled” to another may refer to two separate components that are connected or joined together, or may refer to different sections, segments, or portions of an integrated/monolithic structure that extend relative to each other or that have some other contrasting features, shapes, properties, or the like. Also, as used herein, securing one element to another element can include direct securing and indirect securing. Additionally, as used herein, “adjacent” does not necessarily denote contact. For example, one element can be adjacent another element without being in contact with that element.

The schematic flow chart diagrams included herein are generally set forth as logical flow chart diagrams. As such, the depicted order and labeled steps are indicative of one or more embodiments of the presented method. The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A laser crafting apparatus configured to direct electromagnetic radiation toward a workpiece, the laser crafting apparatus comprising:
a housing;
a lid pivotably coupled to the housing, wherein the housing and the lid collectively at least partially define an internal volume of the laser crafting apparatus;
a rail assembly mounted to the housing; and
a laser carriage assembly coupled to the rail assembly, the laser carriage assembly comprising a laser module configured to emit electromagnetic radiation;
wherein the laser crafting apparatus is configured to move the laser carriage assembly along the rail assembly within the internal volume and relative to the workpiece disposed within the internal volume.

2. The laser crafting apparatus of claim 1, further comprising a material support tray that is removably supported within the internal volume such that a user can position the workpiece on the material support tray when the material support tray is removed from the internal volume of the laser crafting apparatus and subsequently load the material support tray and the workpiece supported thereon into the internal volume.

3-9. (canceled)

10. The laser crafting apparatus of claim 72, wherein the material support tray comprises a rigid mesh body for supporting the workpiece thereon, wherein the rigid mesh body defines a plurality of cells configured to detachably receive a stem portion of the at least one retention clip.

11. The laser crafting apparatus of claim 10, wherein the rigid mesh body has a honeycomb structure.

12-39. (canceled)

40. The laser crafting apparatus of claim 1, further comprising at least one atmospheric sensor configured to detect a composition of air that is at least one of within and flowing out of the internal volume of the laser crafting apparatus.

41. The laser crafting apparatus of claim 1, further comprising at least one temperature sensor configured to detect a temperature of at least one of the laser module and air within the internal volume of the laser crafting apparatus.

42. The laser crafting apparatus of claim 1, further comprising an accelerometer coupled to the laser carriage assembly configured to detect movement (or lack thereof) of the laser carriage assembly.

43. The laser crafting apparatus of claim 1, further comprising a flame sensor configured to detect a presence of flames within the internal volume of the laser crafting apparatus.

44. The laser crafting apparatus of claim 1, further comprising a glass-break sensor configured to detect breakage of the lid.

45-79. (canceled)

80. A lid for a laser crafting apparatus, the lid comprising:
a radiation attenuation layer; and
a fire suppression layer coupled to the radiation attenuation layer.

81. The lid of claim 80, wherein:
the lid has a perimeter that comprises a front edge, a rear edge opposite the front edge, and opposing lateral side edges;
the radiation attenuation layer and the fire suppression layer are parallel to each other; and
both the radiation attenuation layer and the fire suppression layer extend continuously within the perimeter such that a majority of a body mass of the lid is comprised of the radiation attenuation layer and the fire suppression layer.

82. The lid of claim 81, wherein the radiation attenuation layer forms a top exterior surface of the lid, and the fire suppression layer forms a bottom interior surface of the lid that is configured to face an internal volume of the laser crafting apparatus.

83. The lid of claim 82, wherein the radiation attenuation layer comprises at least one of a thermoplastic material and synthetic polymer.

84. (canceled)

85. The lid of claim 82, wherein the radiation attenuation layer is colored to attenuate transmission of electromagnetic radiation from a laser module of the laser crafting apparatus.

86. The lid of claim 82, wherein the fire suppression layer comprises a glass material.

87. The lid of claim 86, wherein the fire suppression layer comprises borosilicate glass.

88. The lid of claim 80, further comprising an intermediate spacer frame disposed between radiation attenuation layer and the fire suppression layer such that a gap is defined between the radiation attenuation layer and the fire suppression layer.

89. The lid of claim 88, wherein the radiation attenuation layer is at least one of adhered and bonded to an upper surface of the intermediate spacer frame.

90. The lid of claim 89, further comprising a base frame having a bottom portion and a sidewall portion, wherein the intermediate spacer frame is coupled to the bottom portion of the base frame via a plurality of fasteners such that the fire suppression layer is securely retained and/or compressed between a lower surface of the intermediate spacer frame and an upper surface of the bottom portion of the base frame.

91. The lid of claim 90, wherein a majority of the plurality of fasteners are positioned outward of a periphery of the fire suppression layer such that the majority of the plurality of fasteners do not extend through the fire suppression layer.

92-105. (canceled)
